(19) United States
(12) Patent Application Publication
(10) Pub. No.: US 2026/0291580 A1
(43) Pub. Date: Sep. 24, 2026

(54) CHANNEL STATE INFORMATION REPORTING

(71) Applicant: QUALCOMM Incorporated, San Diego, CA (US)

(72) Inventors: Kexin XIAO, Shanghai (CN); Hung Dinh LY, San Diego, CA (US); Yu ZHANG, San Diego, CA (US); Lei XIAO, San Jose, CA (US)

(21) Appl. No.: 19/475,948

(22) PCT Filed: May 11, 2023
(86) PCT No.: PCT/CN2023/093476

§ 371 Date: Oct. 16, 2025

(51) Int. Cl. H04B 7/06; H04W 24/10; H04W 72/21

(52) U.S. Cl. CPC H04B 7/0626; H04W 24/10; H04W 72/21

(57) ABSTRACT

Various aspects of the present disclosure generally relate to wireless communication. In some aspects, a user equipment (UE) may receive an indication of a quantity of sub-configurations, of a set of sub-configurations included within a channel state information (CSI) report configuration, to be used by the UE for reporting CSI via a physical uplink shared channel (PUSCH) in a single CSI reporting instance. The UE may report the CSI, via the PUSCH in the single CSI reporting instance, in accordance with the indication of the quantity of sub-configurations. Numerous other aspects are described.

### FIELD OF THE DISCLOSURE

Aspects of the present disclosure generally relate to wireless communication and to techniques and apparatuses for channel state information reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating examples of channel state information (CSI) reference signal beam management procedures, in accordance with the present disclosure.

FIG. 5 is a diagram illustrating an example of CSI reporting, in accordance with the present disclosure.

FIG. 6 is a diagram illustrating an example of CSI reporting, in accordance with the present disclosure.

FIG. 7 is a diagram illustrating an example process performed, for example, by a UE, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### SUMMARY

Some aspects described herein relate to a method of wireless communication performed by a user equipment (UE). The method may include receiving an indication of a quantity of sub-configurations, of a set of sub-configurations included within a channel state information (CSI) report configuration, to be used by the UE for reporting CSI via a physical uplink shared channel (PUSCH) in a single CSI reporting instance. The method may include reporting the CSI, via the PUSCH in the single CSI reporting instance, in accordance with the indication of the quantity of sub-configurations.

Some aspects described herein relate to a method of wireless communication performed by a UE. The method may include receiving an indication of a quantity of sub-configurations, of a set of sub-configurations included within a CSI report configuration, to be used by the UE for semi-persistently reporting via a physical uplink control channel (PUCCH) in a single CSI reporting instance. The method may include reporting the CSI, via the PUCCH in the single CSI reporting instance, in accordance with the indication of the quantity of sub-configurations.

Some aspects described herein relate to a method of wireless communication performed by a network node. The method may include transmitting an indication of a quantity of sub-configurations, of a set of sub-configurations included within a CSI report configuration, to be used by a UE for reporting CSI via a PUSCH in a single CSI reporting instance. The method may include receiving a CSI report, via the PUSCH in the single CSI reporting instance, in accordance with the indication of the quantity of sub-configurations.

Some aspects described herein relate to a method of wireless communication performed by a network node. The method may include transmitting an indication of a quantity of sub-configurations, of a set of sub-configurations included within a CSI report configuration, to be used by a UE for semi-persistently reporting CSI via a PUCCH in a single CSI reporting instance. The method may include receiving a CSI report, via the PUCCH in the single CSI reporting instance, in accordance with the indication of the quantity of sub-configurations.

Some aspects described herein relate to a UE for wireless communication. The user equipment may include one or more memories and a set of one or more processors. The set of one or more processors may be configured to receive an indication of a quantity of sub-configurations, of a set of sub-configurations included within a CSI report configuration, to be used by the UE for reporting CSI via a PUSCH in a single CSI reporting instance. The set of one or more processors may be configured to report the CSI, via the PUSCH in the single CSI reporting instance, in accordance with the indication of the quantity of sub-configurations.

Some aspects described herein relate to a UE for wireless communication. The user equipment may include one or more memories and a set of one or more processors. The set of one or more processors may be configured to receive an indication of a quantity of sub-configurations, of a set of sub-configurations included within a CSI report configuration, to be used by the UE for semi-persistently reporting CSI via a PUCCH in a single CSI reporting instance. The set of one or more processors may be configured to report the CSI, via the PUCCH in the single CSI reporting instance, in accordance with the indication of the quantity of sub-configurations.

Some aspects described herein relate to a network node for wireless communication. The network node may include one or more memories and a set of one or more processors. The set of one or more processors may be configured to transmit an indication of a quantity of sub-configurations, of a set of sub-configurations included within a CSI report configuration, to be used by a UE for reporting CSI via a PUSCH in a single CSI reporting instance. The set of one or more processors may be configured to receive a CSI report, via the PUSCH in the single CSI reporting instance, in accordance with the indication of the quantity of sub-configurations.

Some aspects described herein relate to a network node for wireless communication. The network node may include one or more memories and a set of one or more processors. The set of one or more processors may be configured to transmit an indication of a quantity of sub-configurations, of a set of sub-configurations included within a CSI report configuration, to be used by a UE for semi-persistently reporting CSI via a PUCCH in a single CSI reporting instance. The set of one or more processors may be configured to receive a CSI report, via the PUCCH in the single CSI reporting instance, in accordance with the indication of the quantity of sub-configurations.

Some aspects described herein relate to a non-transitory computer-readable medium that stores a set of instructions for wireless communication by a UE. The set of instructions, when executed by a set of one or more processors, may cause the UE to receive an indication of a quantity of sub-configurations, of a set of sub-configurations included within a CSI report configuration, to be used by the UE for reporting CSI via a PUSCH in a single CSI reporting instance. The set of instructions, when executed by the set of one or more processors, may cause the UE to report the CSI, via the PUSCH in the single CSI reporting instance, in accordance with the indication of the quantity of sub-configurations.

Some aspects described herein relate to a non-transitory computer-readable medium that stores a set of instructions for wireless communication by an UE. The set of instructions, when executed by a set of one or more processors, may cause the UE to receive an indication of a quantity of sub-configurations, of a set of sub-configurations included within a CSI report configuration, to be used by the UE for semi-persistently reporting CSI via a PUCCH in a single CSI reporting instance. The set of instructions, when executed by the set of one or more processors, may cause the UE to report the CSI, via the PUCCH in the single CSI reporting instance, in accordance with the indication of the quantity of sub-configurations.

Some aspects described herein relate to a non-transitory computer-readable medium that stores a set of instructions for wireless communication by a network node. The set of instructions, when executed by a set of one or more processors, may cause the network node to transmit an indication of a quantity of sub-configurations, of a set of sub-configurations included within a CSI report configuration, to be used by a UE for reporting CSI via a PUSCH in a single CSI reporting instance. The set of instructions, when executed by the set of one or more processors, may cause the network node to receive a CSI report, via the PUSCH in the single CSI reporting instance, in accordance with the indication of the quantity of sub-configurations.

Some aspects described herein relate to a non-transitory computer-readable medium that stores a set of instructions for wireless communication by a network node. The set of instructions, when executed by a set of one or more processors, may cause the network node to transmit an indication of a quantity of sub-configurations, of a set of sub-configurations included within a CSI report configuration, to be used by a UE for semi-persistently reporting CSI via a PUCCH in a single CSI reporting instance. The set of instructions, when executed by the set of one or more processors, may cause the network node to receive a CSI report, via the PUCCH in the single CSI reporting instance, in accordance with the indication of the quantity of sub-configurations.

Some aspects described herein relate to an apparatus for wireless communication. The apparatus may include means for receiving an indication of a quantity of sub-configurations, of a set of sub-configurations included within a CSI report configuration, to be used by the UE for reporting CSI via a PUSCH in a single CSI reporting instance. The apparatus may include means for reporting the CSI, via the PUSCH in the single CSI reporting instance, in accordance with the indication of the quantity of sub-configurations.

Some aspects described herein relate to an apparatus for wireless communication. The apparatus may include means for receiving an indication of a quantity of sub-configurations, of a set of sub-configurations included within a CSI report configuration, to be used by the UE for semi-persistently reporting CSI via a PUCCH in a single CSI reporting instance. The apparatus may include means for reporting the CSI, via the PUCCH in the single CSI reporting instance, in accordance with the indication of the quantity of sub-configurations.

Some aspects described herein relate to an apparatus for wireless communication. The apparatus may include means for transmitting an indication of a quantity of sub-configurations, of a set of sub-configurations included within a CSI report configuration, to be used by a UE for reporting CSI via a PUSCH in a single CSI reporting instance. The apparatus may include means for receiving a CSI report, via the PUSCH in the single CSI reporting instance, in accordance with the indication of the quantity of sub-configurations.

Some aspects described herein relate to an apparatus for wireless communication. The apparatus may include means for transmitting an indication of a quantity of sub-configurations, of a set of sub-configurations included within a CSI report configuration, to be used by a UE for semi-persistently reporting CSI via a PUCCH in a single CSI reporting instance. The apparatus may include means for receiving a CSI report, via the PUCCH in the single CSI reporting instance, in accordance with the indication of the quantity of sub-configurations.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

A user equipment (UE) may receive triggering information for reporting channel state information (CSI). In some cases, the UE may receive downlink control information (DCI) that indicates for the UE to aperiodically report a CSI (RS) (collectively, CSI-RS) via a physical uplink shared channel (PUSCH). A list of trigger states may be configured in a CSI aperiodic trigger state list (CSI-AperiodicTriggerStateList), and each trigger state included in the list of trigger states may include a list of associated reporting settings. In some other cases, the UE may receive DCI that indicates for the UE to semi-persistently report the CSI via the PUSCH. A list of trigger states may be configured in a CSI semi-persistent state list (CSI-SemniPersistentOnPUSCH-TriggerStateList), and each trigger state included in the list of trigger states may include a list of associated reporting settings. In some cases, the UE may receive a medium access control (MAC) control element (CE) (collectively, MAC-CE) that indicates for the UE to semi-persistently report the CSI via a physical uplink control channel (PUCCH). For a CSI report configuration with L sub-configuration(s), the UE may be configured to report N CSI(s) in a single reporting instance, where the N CSI(s) are associated with N sub-configuration(s) from L (where 1≤N≤L) and each CSI corresponds to a single sub-configuration. However, existing CSI report configurations may only include a single sub-configuration. A CSI triggering state may not include a mechanism for associating one CSI triggering state with a subset of sub-configurations when the CSI report configuration includes multiple sub-configurations. Additionally, or alternatively, a MAC-CE for activating or deactivating semi-persistent CSI reporting on a PUCCH may not include a mechanism for activating or deactivating a subset of N sub-configurations when the CSI report configuration includes L sub-configurations.

Various aspects generally relate to CSI reporting. Some aspects more specifically relate to CSI reporting using a CSI report configuration that includes multiple sub-configurations. In some aspects, a UE may receive an indication of a number of sub-configurations, of a total number of sub-configurations included within a CSI report configuration, to be used by the UE for reporting CSI via a PUSCH in a single CSI reporting instance. Each sub-configuration may be used by the UE for reporting CSI in accordance with a measurement of a respective CSI of a number of CSI. The number of sub-configurations to be used by the UE for reporting the CSI may be greater than or equal to one, but may be less than or equal to the total number of sub-configurations included within the CSI report configuration. In some examples, the indication may indicate for the UE to aperiodically report the CSI, and the UE may aperiodically report the CSI via the PUSCH in the single CSI reporting instance and in accordance with the indication. In some other examples, the indication may indicate for the UE to semi-persistently report the CSI, and the UE may semi-persistently report the CSI via the PUSCH in the single CSI reporting instance and in accordance with the indication. In some aspects, the UE may receive an indication of a number of sub-configurations, of the total number of sub-configurations included within the CSI report configuration, to be used by the UE for semi-persistently reporting CSI via a PUCCH in a single CSI reporting instance. The indication may be included, for example, within a CSI report configuration indicator or within a semi-persistent indicator. The UE may semi-persistently report the CSI, via the PUCCH in the single CSI reporting instance, in accordance with the indication.

Particular aspects of the subject matter described in this disclosure can be implemented to realize one or more of the following potential advantages. In some examples, by communicating the indication of the number of sub-configurations to be used by the UE for aperiodically reporting CSI via the PUSCH, the described techniques can be used to enable the UE to aperiodically report multiple CSIs via the PUSCH in a single CSI reporting instance. In some examples, by communicating the indication of the number of sub-configurations to be used by the UE for semi-persistently reporting CSI via the PUSCH, the described techniques can be used to enable the UE to semi-persistently report multiple CSIs via the PUSCH in a single CSI reporting instance. In some examples, by communicating the indication of the number of sub-configurations to be used by the UE for semi-persistently reporting CSI via the PUCCH, the described techniques can be used to enable the UE to semi-persistently report multiple CSIs via the PUCCH in a single CSI reporting instance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

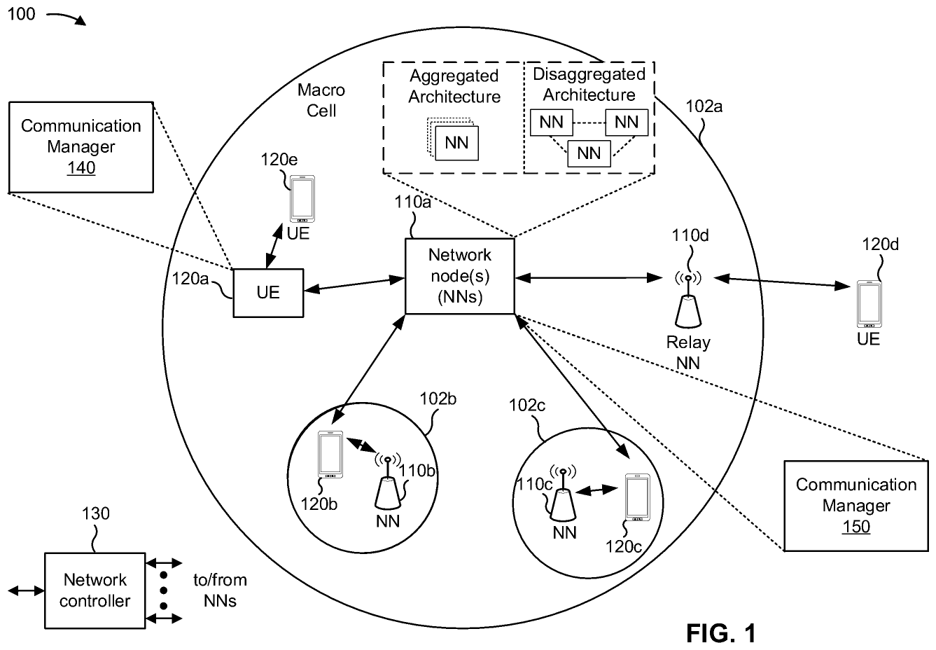

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support an RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a quantity of sub-configurations, of a set of sub-configurations included within a CSI report configuration, to be used by the UE for reporting CSI via a PUSCH in a single CSI reporting instance; and report the CSI, via the PUSCH in the single CSI reporting instance, in accordance with the indication of the quantity of sub-configurations. Additionally, or alternatively, the communication manager 140 may perform one or more other operations described herein.

In some aspects, the communication manager 140 may receive an indication of a quantity of sub-configurations, of a set of sub-configurations included within a CSI report configuration, to be used by the UE for semi-persistently reporting CSI via a PUCCH in a single CSI reporting instance; and report the CSI, via the PUCCH in the single CSI reporting instance, in accordance with the indication of the quantity of sub-configurations. Additionally, or alternatively, the communication manager 140 may perform one or more other operations described herein.

In some aspects, the network node 110 may include a communication manager 150. As described in more detail elsewhere herein, the communication manager 150 may transmit an indication of a quantity of sub-configurations, of a set of sub-configurations included within a CSI report configuration, to be used by a UE for reporting CSI via a PUSCH in a single CSI reporting instance; and receive a CSI report, via the PUSCH in the single CSI reporting instance, in accordance with the indication of the quantity of sub-configurations. Additionally, or alternatively, the communication manager 150 may perform one or more other operations described herein.

In some aspects, the communication manager 150 may transmit an indication of a quantity of sub-configurations, of a set of sub-configurations included within a CSI report configuration, to be used by a UE for semi-persistently reporting CSI via a PUCCH in a single CSI reporting instance; and receive a CSI report, via the PUCCH in the single CSI reporting instance, in accordance with the indication of the quantity of sub-configurations. Additionally, or alternatively, the communication manager 150 may perform one or more other operations described herein.

As indicated above, FIG. 1 is provided as an example. Other examples may differ from what is described with regard to FIG. 1.

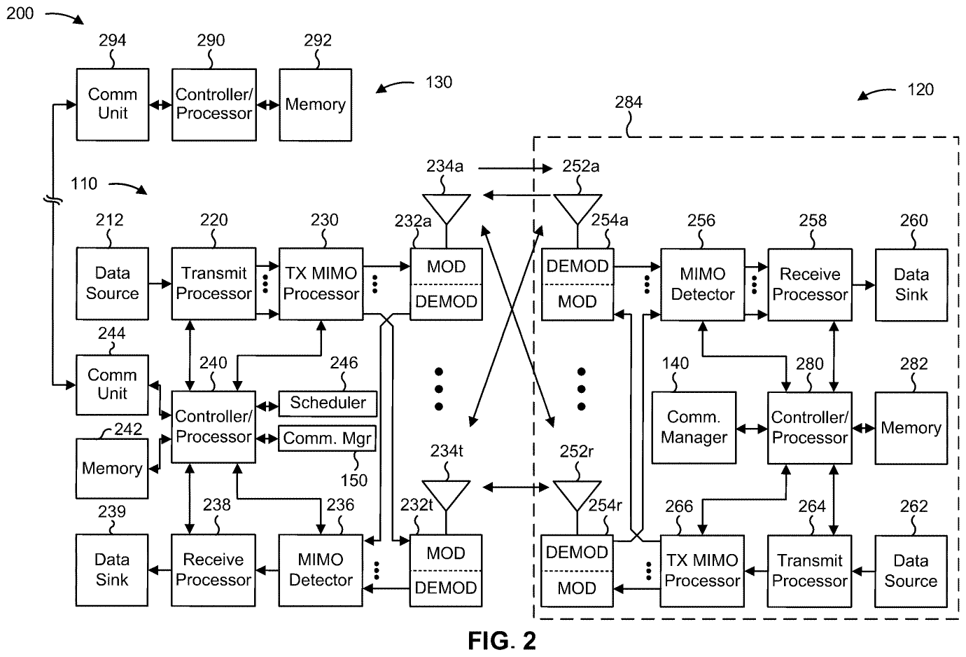

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

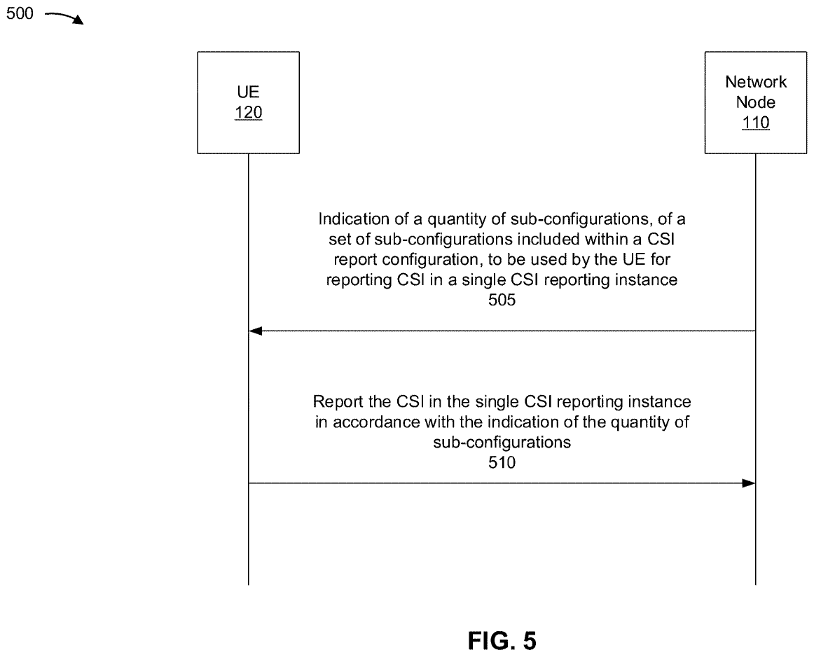

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

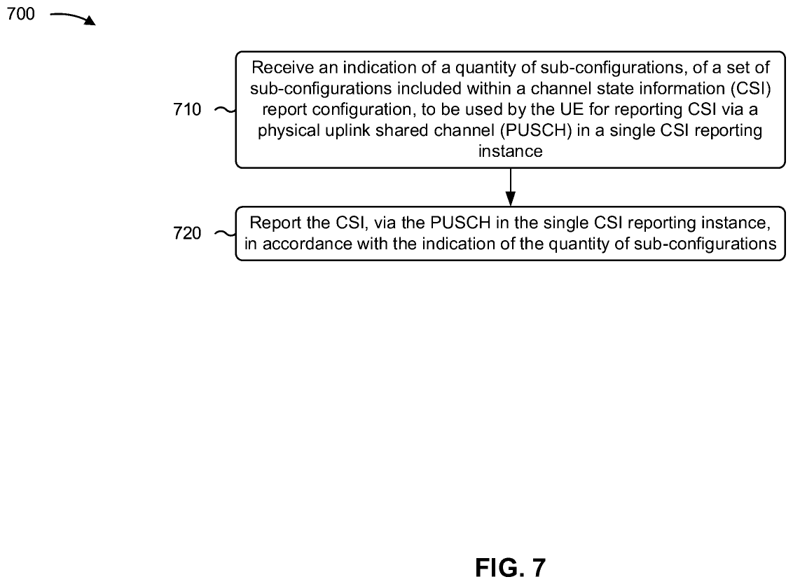

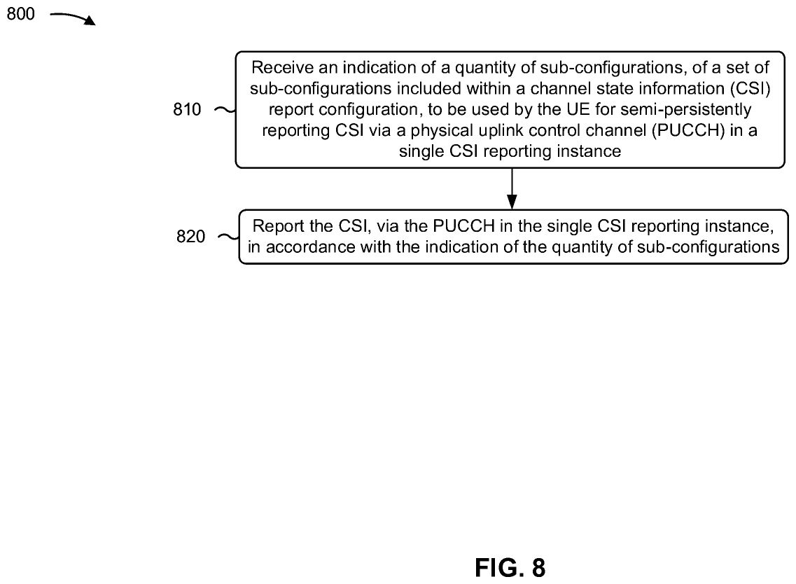

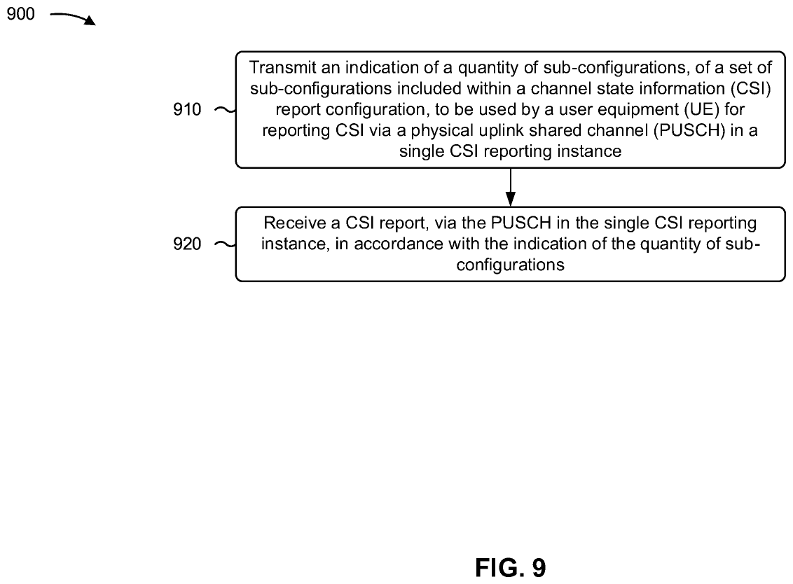

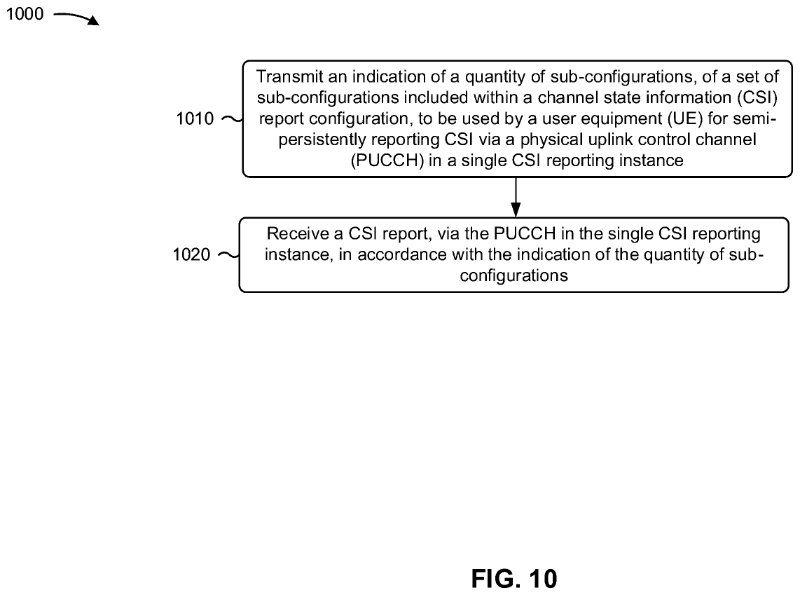

The controller/processor 240 of the network node 110, the controller/processor 280 of the UE 120, and/or any other component(s) of FIG. 2 may perform one or more techniques associated with CSI-RS reporting, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by a set of one or more processors of the network node 110 and/or the UE 120, may cause the set of one or more processors, the UE 120, and/or the network node 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving an indication of a quantity of sub-configurations, of a set of sub-configurations included within a CSI report configuration, to be used by the UE for reporting CSI via a PUSCH in a single CSI reporting instance; and/or means for reporting the CSI, via the PUSCH in the single CSI reporting instance, in accordance with the indication of the quantity of sub-configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving an indication of a quantity of sub-configurations, of a set of sub-configurations included within a CSI report configuration, to be used by the UE for semi-persistently reporting CSI via a PUCCH in a single CSI reporting instance; and/or means for reporting the CSI, via the PUCCH in the single CSI reporting instance, in accordance with the indication of the quantity of sub-configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a quantity of sub-configurations, of a set of sub-configurations included within a CSI report configuration, to be used by a UE for reporting CSI via a PUSCH in a single CSI reporting instance; and/or means for receiving a CSI report, via the PUSCH in the single CSI reporting instance, in accordance with the indication of the quantity of sub-configurations. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node 110 includes means for transmitting an indication of a quantity of sub-configurations, of a set of sub-configurations included within a CSI report configuration, to be used by a UE for semi-persistently reporting CSI via a PUCCH in a single CSI reporting instance; and/or means for receiving a CSI report, via the PUCCH in the single CSI reporting instance, in accordance with the indication of the quantity of sub-configurations. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an LAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

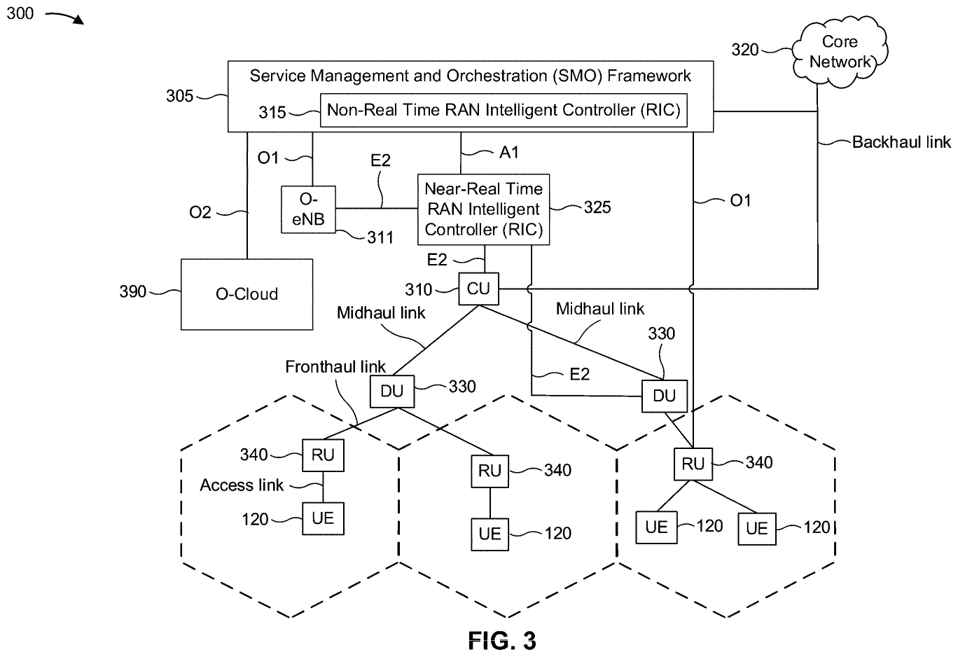

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

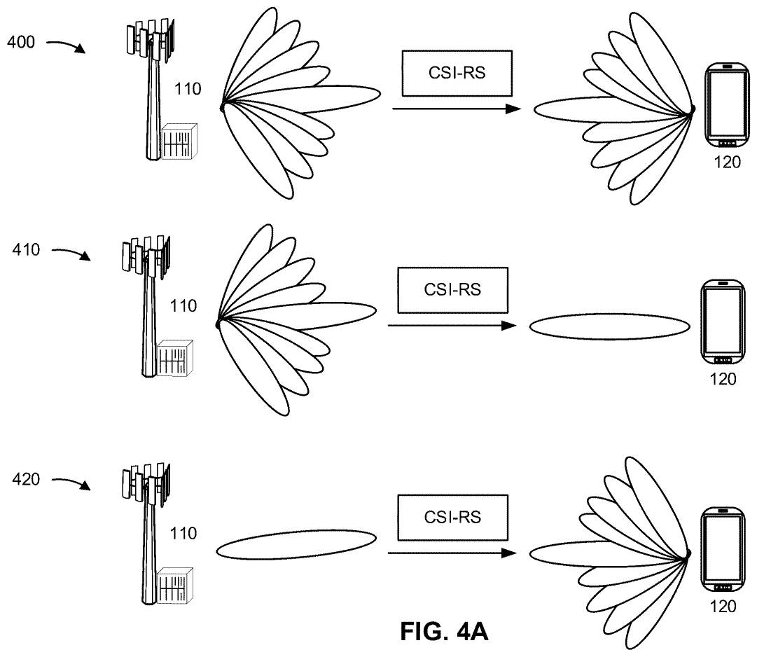

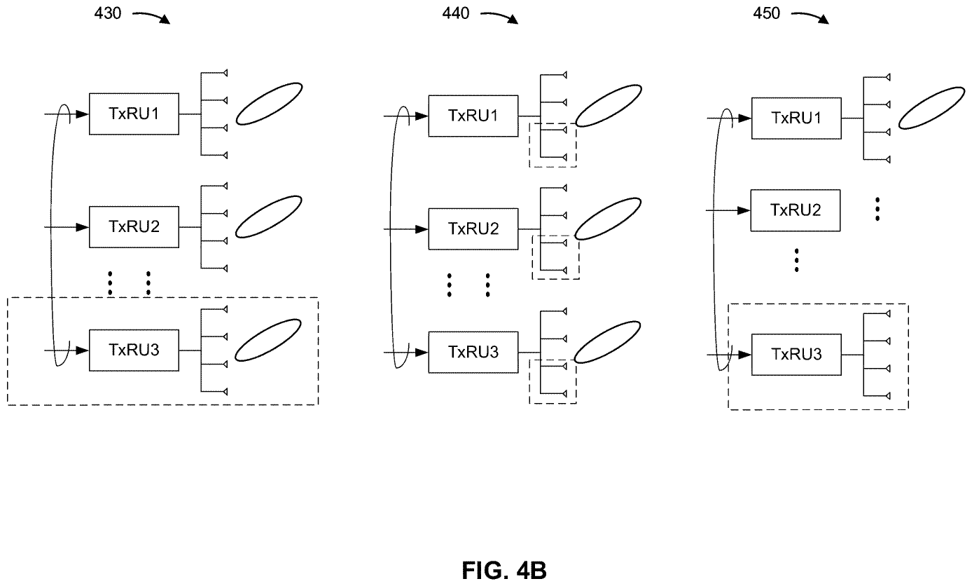

FIGS. 4A-4B are diagrams illustrating examples of CSI-RS beam management procedures, in accordance with the present disclosure. As shown in FIG. 4, a UE 120 is in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Massive MIMO technology may be used for high spectral efficiency and extended coverage. For downlink transmission, massive MIMO equipped with a large number of transceiver chains (e.g., 64 chains in frequency range 1 (FR1) may be deployed in commercial 5G networks, for example, at carrier frequencies of 3.5 gigahertz (GHz) or higher). Each transceiver chain may be connected to one or more power amplifiers. However, the power amplifiers may consume a large amount of network node power, such as seventy to eighty percent of the network node power. To reduce network node power consumption, a cell can turn one or more power amplifiers on or off depending on the time and frequency resource utilization in the cell. In some cases, a cell may be configured to turn one or more transceiver chains on or off.

In some cases, as shown in FIG. 4B and by reference number 430, the on/off capabilities may be associated with a logical antenna port associated with a plurality of transmit receive units (TxRUs) (such as TxRU1, TxRU2, and TxRU3), and the logical antenna port may be turned on or off. This may be referred to as Type 1 spatial domain (SD) adaptation. In some other cases, as shown by reference numbers 440 and 450, the on/off capabilities may be associated with a portion of the antenna elements associated with a logical antenna port, and the portion of the antenna elements associated with the logical antenna port may be turned on or off. This may be referred to as Type 2 SD adaptation.

In some cases, such as from a CSI perspective, Type 1 SD adaptation may be the adaptation of antenna ports or transceiver chains at network node. In contrast, Type 2 SD adaptation may be the adaptation of transmission power offset values between CSI-RS and SSB.

In some cases, non-zero power (NZP) CSI-RS resource configuration for channel measurement within one resource setting corresponding to more than one spatial adaptation patterns may be supported. In some cases, a resource set with multiple resources may be configured within a resource setting, where each resource is associated with only one spatial adaptation pattern. In some other cases, for a resource configured in a resource set within a resource setting, the resource can be associated with more than one spatial adaptation patterns. One or more resources can be configured in the resource set for channel measurement. In some cases, one CSI report configuration may include multiple CSIs report sub-configurations, where each sub-configuration corresponds to a single spatial adaptation pattern.

In some cases, a CSI feedback (CSF) framework may include multiple steps. A first step (e.g., step 1) may be associated with CSF for adaptation of spatial elements. A second step (e.g., step 2) may be associated with identifying a physical downlink shared channel (PDSCH) with a suitable configuration of spatial elements. In some cases, for a CSI report configuration with L sub-configuration(s), a framework that enables a UE to report N CSI(s) in one reporting instance, where the N CSI(s) are associated with N sub-configuration(s) from L (where 1≤N≤L) and each CSI corresponds to one sub-configuration, may be supported. N=1 may refer to single-CSI signaling while N>1 may refer to multi-CSI signaling.

In some cases, for a CSI report configuration, for each sub-configuration for Type 1 SD adaptation, at least the following may be included: one or more parameters in a codebook configuration (CodebookConfig), and a port subset indication or resource grouping. The one or more parameters in the codebook configuration may include, for example, n1-n2, and ng for multi-panel. In some cases, the one or more parameters may also include a rank restriction, a codebook subset restriction, and/or supported codebook types for a precoding matrix indicator (PMI) (e.g., Type-I or Type-II). The port subset indication or resource grouping may indicate, for example, a report quantity, a report frequency configuration (reportFreqConfiguration), and/or whether it is explicitly provided or can also be derived (e.g., from the CodebookConfig and/or from the CSI-RS resource configuration). For a CSI report configuration, at least the following can be included for each sub-configuration for Type 2 SD adaptation: an NZP CSI-RS resource set for channel measurement, where different resources can have different power offsets between a CSI-RS and SSB. In some cases, a report quantity can also be included.

In one example, a CSI report configuration for Type 1 SD adaptation in accordance with a port subset indication may have three sub-configurations. The CSI report configuration may have a 32-port NZP CSI-RS resource set (for channel measurement). A first sub-configuration (sub-configuration 1) may have a first spatial adaptation pattern (spatial adaptation pattern 1) and may have a first codebook configuration (codebook configuration 1) with (N1, N2)=(8, 2). A second sub-configuration (sub-configuration 2) may have a second spatial adaptation pattern (spatial adaptation pattern 2) and may have a second codebook configuration (codebook configuration 2) with (N1, N2)=(8, 1). Additionally, the second sub-configuration may have 16-port NZP CSI-RS resource(s), where each resource is a subset of a 32-port CSI-RS resource in a CSI-RS resource set and corresponds to a uniform linear array (ULA) with (N1, N2) in codebook 2. A third sub-configuration (sub-configuration 3) may have a third spatial adaptation pattern (spatial adaptation pattern 3) and may have a third codebook configuration (codebook configuration 3) with (N1, N2)=(4, 1). Additionally. The third sub-configuration may have 8-port NZP CSI-RS resource(s), where each resource is a subset of a 32-port CSI-RS resource in a CSI-RS resource set and corresponds to a ULA with (N1, N2) in codebook 3. In some cases, the resource subset may be determined based at least in part on a port subset indication.

In another example, a CSI report configuration for Type 1 SD adaptation, in accordance with resource grouping may have three sub-configurations. The CSI report configuration may have a 32-port NZP CSI-RS resource set (for channel measurement). A first sub-configuration (sub-configuration 1) may have a first spatial adaptation pattern (spatial adaptation pattern 1) and may have a first codebook configuration (codebook configuration 1) with (N1, N2)=(8, 2). A second sub-configuration (sub-configuration 2) may have a second spatial adaptation pattern (spatial adaptation pattern 2) and may have a second codebook configuration (codebook configuration 2) with (N1, N2)=(8, 1). Additionally, the second sub-configuration may have a 16-port NZP CSI-RS resource set for channel measurement. A third sub-configuration (sub-configuration 3) may have a third spatial adaptation pattern (spatial adaptation pattern 3) and may have a third codebook configuration (codebook configuration 3) with (N1, N2)=(4, 1). Additionally, the third sub-configuration may have an 8-port NZP CSI-RS resource set for channel measurement. In some cases, there may be no relationship between the resources in the different sub-configurations.

In one example, for Type 2 SD adaptation, a CSI report configuration may include three sub-configurations. A P-port NZP CSI-RS resource set (for channel measurement) may include: sub-configuration 1 that includes a first group of P-port NZP CSI-RS resources, sub-configuration 2 that includes a second group of P-port NZP CSI-RS resources, and sub-configuration 3 that includes a third group of P-port NZP CSI-RS resources.

In another example, for Type 2 SD adaptation, a CSI report configuration may include three sub-configurations. A P-port NZP CSI-RS resource set (for channel measurement) may include: sub-configuration 1 that includes a first power offset between a CSI-RS and an SSB, sub-configuration 2 that includes a second power offset between a CSI-RS and an SSB, and sub-configuration 3 that includes a third power offset between a CSI-RS and an SSB.

In some cases, a dynamic adaptation of power offset values between PDSCH and CSI-RS may be beneficial for network energy savings. A network node may be able to compensate for some measurements (such as Layer 1 (L1) RSRP and CQI) in accordance with a transmission power difference between an actual power offset and a configured power offset used by the UE for the CSI report. This may be beneficial when the transmission power difference is not large. However, when the transmission power difference is large, the compensation at the network node may not be accurate for parameters such as rank indicator (RI) and/or PMI. In some cases, the dynamic adaptation of the power offset values between PDSCH and CSI-RS can be identified in accordance with an example two-step process. In a first step (e.g., step 1), a CSF for adaptation of power offset values may be identified. In a second step (e.g., step 2), a PDSCH with a suitable power offset configuration may be identified. In some cases, a configuration of more than one power offset value for the PDSCH relative to the CSI-RS may be supported.

In some cases, a framework for power domain (PD) adaptation may be similar to the framework for the spatial domain adaptation described above (e.g., for Type 2 SD). Differences between the SD adaptation and the PD adaptation may be in the sub-configurations, as described below.

For a CSI report configuration with L sub-configuration(s), a framework that enables a UE to report N CSI(s) in one reporting instance, where the N CSI(s) are associated with N sub-configuration(s) from L (where 1≤N≤L) and each CSI corresponds to one sub-configuration, may be supported. N=1 may refer to single-CSI while N>1 may refer to multi-CSI.

In one example of a CSI report configuration for PD adaptation, the CSI report configuration may include three sub-configurations. A P-port NZP CSI-RS resource set (for channel measurement) may include a first sub-configuration (sub-configuration 1) that includes a first group of P-port NZP CSI-RS resources, a second sub-configuration (sub-configuration 2) that includes a second group of P-port NZP CSI-RS resources, and a third sub-configuration (sub-configuration 3) that includes a third group of P-port NZP CSI-RS resources. Different resources in a sub-configuration may have a same CSI-RS pattern but with different power offsets between the PDSCH and CSI-RS.

In another example of a CSI report configuration for PD adaptation, the CSI report configuration may include three sub-configurations. A P-port NZP CSI-RS resource set (for channel measurement) may include a first sub-configuration (sub-configuration 1) that includes a first power offset between the PDSCH and CSI-RS resources, a second sub-configuration (sub-configuration 2) that includes a second power offset between the PDSCH and CSI-RS resources, and a third sub-configuration (sub-configuration 3) that includes a third power offset between the PDSCH and CSI-RS resources.

In some cases, for Type 2 SD adaptation, a sub-configuration may relate to the power offset between the CSI-RS and SSB. This may be different than the PD adaptation. For example, a power offset between the PDSCH and CSI-RS may be a hypothetical power offset that the UE assumes for CSI measurement. However, the power offset between the CSI-RS and SSB is not hypothetical. The network node may need to transmit a CSI-RS with an actual signaled offset as specified in the 3GPP Specification, TS 38.214: The downlink CSI-RS energy per resource element (EPRE) can be derived from the synchronization signal (SS)/physical broadcast channel (PBCH) block downlink transmit power given by the parameter ss-PBCH-BlockPower and CSI-RS power offset given by the parameter powerControlOffsetSS provided by higher layers, where the CSI-RS is quasi-co-located with the SS/PBCH block, and the SS/PBCH block can be associated with serving cell physical cell identifier (PCI) or additional PCI different from serving cell PCI.

In some cases, an NR CSI feedback framework may include reporting settings, resource settings, and a list of trigger states. The reporting settings may be configured in a CSI report configuration (CSI-ReportConfig), the resource settings may be configured in a CSI resource configuration (CSI-ResourceConfig), and the list of trigger states may be configured in a CSI aperiodic trigger state list (CSI-AperiodicTriggerStateList) and/or a CSI semi-persistent (SP) configuration on physical uplink shared channel trigger state list (CSI-SemiPersistentOnPUSCH-TriggerStateList). Each trigger state in the list of trigger states may include a list of associated reporting settings.

In some cases, each reporting setting may include one or more of the following parameters: a codebook configuration including codebook subset restriction information indicated in the record CodebookConfig, a time-domain behavior indicated by reportConfigType, a frequency granularity for CQI and PMI, a CSI band defining the frequency sub-bands in which the CSI report is valid, a measurement restriction configured by timeRestrictionForChannelMeasurements and timeRestrictionForInterferenceMeasurements, each of which controls whether the UE is allowed to perform time averaging for the relevant quantity, and/or CSI-related quantities to be reported by the UE such as the layer indicator (L1), L1-RSRP, CSI-RS resource indicator (CRI), SSBRI (SSB Resource Indicator), RI, PMI and CQI. The codebook configuration including the codebook subset restriction indicates in the record CodebookConfig may indicate, for example, a Type 1 single-panel codebook (CodebookType set to typel-SinglePanel), a Type 1 multi-panel codebook (CodebookType set to typel-MultiPanel), a Type II codebook without port selection (CodebookType set to typeII), and/or a Type II codebook with port selection (CodebookType set to typeII-PortSelection). The time-domain behavior indicated by the reportConfigType can be set to aperiodic, semiPersistentOnPUCCH, semiPersistentOnPUSCH, or periodic.

In some cases, each CSI resource setting may be a collection of measurement resources of a given type and may include a list of CSI resource sets given by a higher layer parameter csi-RS-ResourceSetList. The following may be configured for a CSI resource setting: NZP CSI-RS resource for channel measurement, NZP CSI-RS resource for interference measurement, or CSI interference measurement (CSI-IM) resource for interference measurement. In some examples, there can be one, two, or three resource settings configured for each reporting setting. Table I summarizes example combinations of CSI resource time domain behavior and CSI reporting time domain configurations.

TABLE 1
Example CSI Reporting and CSI Resource Configurations

| | | CSI Report Configuration | | |
|---|---|---|---|---|
| | | Periodic | Semi-Persistent | Aperiodic |
| | | CSI Reporting | CSI Reporting | CSI Reporting |
| CSI Resource | Periodic | Supported | Supported | Supported |
| Configuration | CSI-RS | No dynamic | For reporting on | Triggered by |
| | | triggering/activation | PUCCH, the UE | DCI |
| | | Reporting on | receives an | Reporting on |
| | | PUCCH | activation | PUSCH |
| | | | command MAC- | |
| | | | CE | |
| | | | For reporting on | |
| | | | PUSCH, the UE | |
| | | | receives triggering | |
| | | | on DCI | |
| | Semi- | Not Supported | Supported | Supported |
| | Persistent | | For reporting on | Triggered by |
| | CSI-RS | | PUCCH, the UE | DCI |
| | | | receives an | Reporting on |
| | | | activation | PUSCH |
| | | | command MAC- | |
| | | | CE | |
| | | | For reporting on | |
| | | | PUSCH, the UE | |
| | | | receives triggering | |
| | | | on DCI | |
| | Aperiodic | Not Supported | Not Supported | Supported |
| | CSI-RS | | | Triggered by |
| | | | | DCI |
| | | | | Reporting on |
| | | | | PUSCH |

As described in 3GPP TS 38.321 section 5.18.6, for reporting on a PUCCH, the UE may receive an activation command via a MAC-CE. The network may activate and deactivate the configured semi-persistent CSI reporting on the PUCCH of a serving cell by sending the SP CSI reporting on a PUCCH activation/deactivation MAC-CE. The configured semi-persistent CSI reporting on the PUCCH may be initially deactivated upon configuration and after a handover. In this case, if the MAC entity receives an SP CSI reporting on PUCCH activation/deactivation MAC-CE on a serving cell, the MAC entity may indicate, to lower layers, the information regarding the SP CSI reporting on PUCCH activation/deactivation MAC-CE. In some cases, the SP CSI on PUCCH activation/deactivation MAC-CE may be identified by a MAC subheader with a logical channel ID (LCID). The MAC subheader may have a serving cell ID field, a bandwidth part (BWP) ID field, an Si field, and a reserved bit (R) field, as described in as described in 3GPP TS 38.321 section 6.1.3.16.

In some cases, a UE may receive triggering information for reporting CSI. In some cases, the UE may receive DCI that indicates for the UE to aperiodically report CSI via a PUSCH. A list of trigger states may be configured in a CSI aperiodic trigger state list (CSI-AperiodicTriggerStateList), and each trigger state included in the list of trigger states may include a list of associated reporting settings. In some other cases, the UE may receive DCI that indicates for the UE to semi-persistently report CSI via the PUSCH. A list of trigger states may be configured in a CSI semi-persistent state list (CSI-SemiPersistentOnPUSCH-TriggerStateList), and each trigger state included in the list of trigger states may include a list of associated reporting settings. In some other cases, the UE may receive a MAC-CE that indicates for the UE to semi-persistently report CSI via a PUCCH. In some cases, for a CSI report configuration with L sub-configuration(s), the UE may be configured to report N CSI(s) in a single reporting instance, where the N CSI(s) are associated with N sub-configuration(s) from L (where 1≤N≤L) and each CSI corresponds to a single sub-configuration. However, existing CSI report configurations may only include a single sub-configuration. A CSI triggering state may not include a mechanism for associating one CSI triggering state with a subset of sub-configurations when the CSI report configuration includes multiple sub-configurations. Additionally, or alternatively, a MAC-CE for activating or deactivating semi-persistent CSI reporting on a PUCCH may not include a mechanism for activating or deactivating a subset of N sub-configurations when the CSI report configuration includes L sub-configurations.

As indicated above, FIGS. 4A-4B are provided as examples. Other examples may differ from what is described with regard to FIGS. 4A-4B.

FIG. 5 is a diagram illustrating an example 500 of CSI reporting, in accordance with the present disclosure.

As shown by reference number 505, the UE 120 may receive an indication of a quantity of sub-configurations to be used by the UE for reporting CSI in a single CSI reporting instance. The quantity of sub-configurations may correspond to a quantity of sub-configurations of a set of sub-configurations (e.g., a total quantity of sub-configurations) included within a CSI report configuration. In one example, the quantity of sub-configurations is represented by N, and the set of sub-configurations is represented by L, where 1≤N≤L. Each sub-configuration of the set of sub-configurations included in the CSI report configuration may be used by the UE 120 for reporting CSI in accordance with a measurement of a respective CSI of a quantity of CSIs. The UE 120 may receive the indicator of the number of sub-configurations from the network node 110.

In some aspects, the quantity of sub-configurations may be used by the UE for aperiodically reporting CSI via a PUSCH in the single reporting instance. For aperiodic CSI reporting via the PUSCH, an indication within a CSI aperiodic trigger state (CSI-AperiodicTriggerState) may be used to indicate a subset of N sub-configurations in a CSI-RS report configuration containing L sub-configurations to be used by the UE 120 for aperiodically reporting N CSIs in the single CSI reporting instance.

In some aspects, the indication of the number of sub-configurations may be included within a field (e.g., a new field and/or a dedicated field). The field may be included, for example, within the CSI aperiodic trigger state indicator. In one example, a single value in the field may be applied to a single associated report configuration identifier (AssociatedReportConfigID) in an associated report configuration information list (associatedReportConfigInfoList) (using a one-to-one mapping). An example is shown below:

```
CSI-AperiodicTriggerState 1 {
  • associatedReportConfigInfoList = {AssociatedReportConfigID1,
  AssociatedReportConfigID2}
  • associatedSubConfig = {1-2-3, 2-3}
}
meaning sub-configurations 1/2/3 for
AssociatedReportConfigID1 and sub-
configuration 2/3 for AssociatedReportConfigID2.
CSI-AperiodicTriggerState 2 {
  • associatedReportConfigInfoList = {AssociatedReportConfigID1,
  AssociatedReportConfigID2}
  • associatedSubConfig = {1-2, 1-2-3}
}
CSI-AperiodicTriggerState 3{
  • associatedReportConfigInfoList = {AssociatedReportConfigID1,
  AssociatedReportConfigID2}
  • associatedSubConfig = {2, 1-3}
}
```

In another example, a single value in the field may be applied to multiple associated report configuration identifiers in the associated report configuration information list (using a one-to-many mapping). An example is shown below:

```
CSI-AperiodicTriggerState 1 {
  • associatedReportConfigInfoList = {AssociatedReportConfigID1,
  AssociatedReportConfigID2}
  • associatedSubConfig = {1-2-3}
}
CSI-AperiodicTriggerState 2 {
  • associatedReportConfigInfoList = {AssociatedReportConfigID1,
  AssociatedReportConfigID2}
  • associatedSubConfig = {1-2}
}
CSI-AperiodicTriggerState 3{
  • associatedReportConfigInfoList = {AssociatedReportConfigID1,
  AssociatedReportConfigID2}
  • associatedSubConfig = {2}
}
```

In some aspects, the indication of the number of sub-configurations may be included within an associated report configuration identifier (e.g., within each associated report configuration identifier) within CSI associated report configuration information (CSI-associatedReportConfigInfo). The indication of the number of sub-configurations may be customized for each associated report configuration identifier. An example is shown below:

```
CSI-AperiodicTriggerState 1 {
  • associatedReportConfigInfoList = {AssociatedReportConfigID1}
} AssociatedReportConfigID1
{
  • ReportConfigID1
  • associatedSubConfig = {1-2-3}
}
CSI-AperiodicTriggerState 2
  • associatedReportConfigInfoList = {AssociatedReportConfigID1}
} AssociatedReportConfigID1
{
  • ReportConfigID1
  • associatedSubConfig = {1-2}
}
CSI-AperiodicTriggerState 3
  • associatedReportConfigInfoList = {AssociatedReportConfigID1}
} AssociatedReportConfigID1
{
  • ReportConfigID1
  • associatedSubConfig = {2}
}
```

In some aspects, the quantity of sub-configurations may be used by the UE for semi-persistently reporting the CSI via the PUSCH in the single reporting instance. For semi-persistent CSI reporting via the PUSCH, an indication in a CSI semi-persistent state indicator (CSI-SemiPersistentOnPUSCH-TriggerState) may be used to indicate the subset of N sub-configurations in the CSI-RS report configuration containing the L sub-configurations to be used by the UE 120 for semi-persistently reporting the N CSIs in the single CSI reporting instance. In some aspects, a field (e.g., a new field and/or a dedicated field) may be included within the CSI semi-persistent state indicator to indicate the number of sub-configurations for semi-persistently reporting the CSI. If no indication of the number of sub-configurations is provided by the network node 110 or received by the UE 120, the UE 120 may use a default value, such as N=L or a default value that is in accordance with a sub-configuration indication associated with another trigger state. An example of semi-persistent PUSCH reporting is shown below:

| CSI-SemiPersistentOnPUSCH-TriggerState ::= SEQUENCE { | |
|---|---|
| associatedReportConfigInfo | CSI-ReportConfigId, |
| associatedSubconfigInfo | subsetSubConfigIndexList } |

```
For example:
CSI-SemiPersistentOnPUSCH-TriggerState 1
  • associatedReportConfigInfo CSI-ReportConfigId1,
  • associatedSubconfigInfo 1-2-3
CSI-SemiPersistentOnPUSCH-TriggerState 2
  • associatedReportConfigInfo CSI-ReportConfigId1,
  • associatedSubconfigInfo 2-3
CSI-SemiPersistentOnPUSCH-TriggerState 3
  • associatedReportConfigInfo CSI-ReportConfigId1,
  • associatedSubconfigInfo 1
```

In some aspects, the quantity of sub-configurations may be used by the UE for semi-persistently reporting the CSI via a PUCCH in the single reporting instance. A field (e.g., a new field and/or a dedicated field), such as a field that is included within a CSI report configuration indicator (CSI-reportConfig) or within a semi-persistent indicator (semiPersistentOnPUCCH), may be used to list all of the sub-configurations for each report configuration identifier (reportConfigID). In one example, the field may list all of the sub-configurations, and each element in the list may represent a specific sub-configuration. This may be represented as follows:

associatedSubconfigInfoList SEQUENCE
(SIZE (1..maxNrofSubconfigurations)) OF
Sub-configuration.

In another example, the field may list all of the possible sub-configuration combinations, and each element in the list may represent a specific sub-configuration combination. This may be represented as follows:

associatedSubconfigInfoList SEQUENCE (SIZE
(1..maxNrofSubconfigurationCombination))
OF Sub-configurationCombination.
Sub-configurationCombination 1
{sub-configuration 1, sub-configuration 2}
Sub-configuration Combination 2 {sub-configuration 1}.

A MAC-CE format may be changed for semi-persistent reporting on PUCCH activation or deactivation for a subset of the sub-configurations. In some aspects, a bitmap (Tₖ₀, Tₖ₁, . . . , T_{kM}) may be used to indicate the sub-configurations or the sub-configuration combinations in a CSI report configuration that is represented by Sₖ. The Sₖ field may be set to a first value (e.g., one) to indicate that the corresponding semi-persistent CSI report configuration k is to be active, and each sub-configuration may be active or inactive in accordance with Tₖₗ being set to one or zero, respectively. Alternatively, the Sₖ field may be set to a second value (e.g., zero) to indicate that the corresponding semi-persistent CSI report configuration k is to be inactive (regardless of whether Tₖₗ is set to one or zero). In some aspects, Tₖₗ may be located adjacent to Sₖ within an octet or may occupy multiple octets. The total number of occurrences M, where Tₖₗ, l=1, . . . , M, may depend on a maximum number of sub-configurations or sub-configuration combinations in the CSI-RS report configuration. In some other aspects, Sₖ (or multiple Sₖ occurrences) may be located within an octet. For the case of a single Sₖ within an octet, Sₖ may be the most significant bit (MSB) within the octet or may be the least significant bit (LSB) within the octet. In some aspects, the MSB (and one or more other bits) in the octet may be reserved in accordance with the number of Sₖ+Tₖₗ, l=1, 2, . . . , M being less than 8.

In some aspects, a legacy MAC-CE format may be enhanced. In a first example, if an additional constraint is introduced that only one CSI report configuration can be activated (e.g., only one Sₖ=1 and others are set to 0), the MAC-CE format may be as follows:

| | | |
|---|---|---|
| R | Serving Cell ID | BWP ID |

| | | | | | | | |
|---|---|---|---|---|---|---|---|
| R₃ | R₂ | R₁ | R₀ | S₃ | S₂ | S₁ | S₀ |

(R0, R1, R2, R3) may be used to indicate the configuration subset for the associated CSI report configuration referred by Sₖ=1.

In a second example, if an additional constraint is introduced that only up to two CSI report configurations can be activated/deactivated, the MAC-CE format may be as follows:

| | | |
|---|---|---|
| R | Serving Cell ID | BWP ID |

| | | | | | | | |
|---|---|---|---|---|---|---|---|
| R₃ | R₂ | R₁ | R₀ | S₃ | S₂ | S₁ | S₀ |

(R0, R1) may be used to indicate the configuration subset for the associated CSI report configuration referred by Sᵢ=1. (R3, R2) may be used to indicate the configuration subset for the associated CSI report configuration referred by Sⱼ=1 (j>i).

In a third example, if an additional constraint is introduced that only two CSI report configurations (instead of four) can be activated/deactivated (e.g., S0, S1), the MAC-CE format may be as follows:

| | | |
|---|---|---|
| R | Serving Cell ID | BWP ID |

| | | | | | | | |
|---|---|---|---|---|---|---|---|
| R₃ | R₂ | R₁ | R₀ | S₃ | S₂ | S₁ | S₀ |

(R0. S3, S2) may be used to indicate the configuration subset for the associated CSI report configuration referred by S0. (R3, R2, R1) may be used to indicate the configuration subset for the associated CSI report config referred by S1.

In a fourth example, if an additional constraint is introduced that only three CSI report configurations can be activated/deactivated (e.g., S0, S1, S2), the MAC-CE format may be as follows:

| | | |
|---|---|---|
| R₄ | Serving Cell ID | BWP ID |

| | | | | | | | |
|---|---|---|---|---|---|---|---|
| R₃ | R₂ | R₁ | R₀ | S₃ | S₂ | S₁ | S₀ |

(R0, S3) may be used to indicate the configuration subset for the associated CSI report configuration referred by S0. (R2, R1) may be used to indicate the configuration subset for the associated CSI report configuration referred by S1. (R4, R3) may be used to indicate the configuration subset for the associated CSI report configuration referred by S2.

In some aspects, a new MAC-CE format may be used. An example of a MAC-CE format with multiple Sₖ included within an octet is shown below:

| | | |
|---|---|---|
| R | Serving Cell ID | BWP ID |

| | | | | | | | |
|---|---|---|---|---|---|---|---|
| S₁ | T₁₂ | T₁₁ | T₁₀ | S₀ | T₀₂ | T₀₁ | T₀₀ |
| S₃ | T₃₂ | T₃₁ | T₃₀ | S₂ | T₂₂ | T₂₁ | T₂₀ |

where (Tₖ₂, Tₖ₁, Tₖ₀) is a bitmap of the sub-configurations in the CSI report configuration that is referred by Sₖ.

An example of a MAC-CE format with multiple Sₖ included within an octet, where Sₖ in the MSB of the octet, is shown below:

| | | |
|---|---|---|
| R | Serving Cell ID | BWP ID |

| | | | | | | | |
|---|---|---|---|---|---|---|---|
| S₀ | T₀₆ | T₀₅ | T₀₄ | T₀₃ | T₀₂ | T₀₁ | T₀₀ |
| S₁ | T₁₆ | T₁₅ | T₁₄ | T₁₃ | T₁₂ | T₁₁ | T₁₀ |
| S₂ | T₂₆ | T₂₅ | T₂₄ | T₂₃ | T₂₂ | T₂₁ | T₂₀ |
| S₃ | T₃₆ | T₃₅ | T₃₄ | T₃₃ | T₃₂ | T₃₁ | T₃₀ |

An example of a MAC-CE format with multiple Sₖ included within an octet, where Sₖ in the LSB of the octet, is shown below:

| | | |
|---|---|---|
| R | Serving Cell ID | BWP ID |

| | | | | | | | |
|---|---|---|---|---|---|---|---|
| T₀₆ | T₀₅ | T₀₄ | T₀₃ | T₀₂ | T₀₁ | T₀₀ | S₀ |
| T₁₆ | T₁₅ | T₁₄ | T₁₃ | T₁₂ | T₁₁ | T₁₀ | S₁ |
| T₂₆ | T₂₅ | T₂₄ | T₂₃ | T₂₂ | T₂₁ | T₂₀ | S₂ |
| T₃₆ | T₃₅ | T₃₄ | T₃₃ | T₃₂ | T₃₁ | T₃₀ | S₃ |

An example of a MAC-CE format with Sₖ and Tₖₗ, l=1, . . . , L octets cross multiple lines:

| | | |
|---|---|---|
| R | Serving Cell ID | BWP ID |

| | | | | | | | |
|---|---|---|---|---|---|---|---|
| S₀ | T₀₆ | T₀₅ | T₀₄ | T₀₃ | T₀₂ | T₀₁ | T₀₀ |
| R | T₁₃ | T₁₂ | T₁₁ | T₁₀ | T₀₉ | T₀₈ | T₀₇ |

An example of a MAC-CE format with MSB (or more) bits in an octet:

| | | |
|---|---|---|
| R | Serving Cell ID | BWP ID |

| | | | | | | | |
|---|---|---|---|---|---|---|---|
| R | S₀ | T₀₅ | T₀₄ | T₀₃ | T₀₂ | T₀₁ | T₀₀ |
| R | S₁ | T₁₅ | T₁₄ | T₁₃ | T₁₂ | T₁₁ | T₁₀ |
| R | S₂ | T₂₅ | T₂₄ | T₂₃ | T₂₂ | T₂₁ | T₂₀ |
| R | S₃ | T₃₅ | T₃₄ | T₃₃ | T₃₂ | T₃₁ | T₃₀ |

As shown by reference number 510, the UE 120 may report (e.g., to the network node 110) the CSI in the single CSI reporting instance in accordance with the indication of the quantity of sub-configurations. In one example, the UE 120 may report the CSI aperiodically via the PUSCH. In another example, the UE 120 may report the CSI semi-persistently via the PUSCH. In another example, the UE 120 may report the CSI semi-persistently via the PUCCH.

As indicated above, FIG. 5 is provided as an example. Other examples may differ from what is described with regard to FIG. 5.

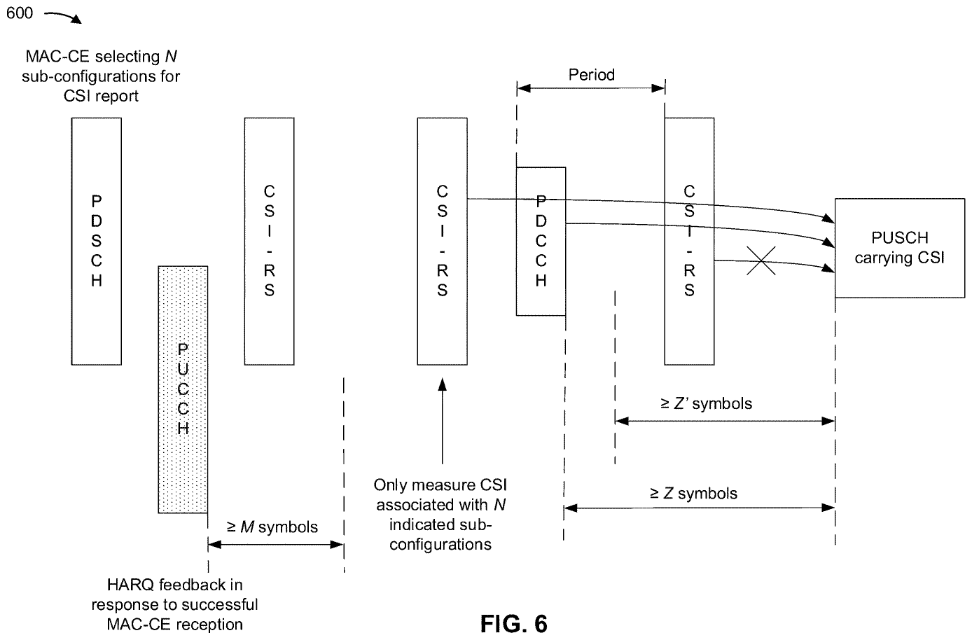

FIG. 6 is a diagram illustrating an example of CSI reporting, in accordance with the present disclosure. In some cases, a number of CSI-RS resources for CSI measurement that are active at the same time (e.g., simultaneously) may be counted. When the indication is part of the CSI trigger state, as described herein, the active CSI-RS resources and the active CSI-RS ports may be counted differently depending on whether the CSI-RS is aperiodic or periodic/semi-persistent. If the CSI-RS is aperiodic, the CSI-RS may be available for CSI measurement after receiving a physical downlink control channel (PDCCH) transmission with DCI containing a CSI trigger but at least Z′ symbols before the first symbol where the UE is scheduled to transmit a PUSCH carrying the CSI. For aperiodic CSI reporting, if a CSI-RS resource set for channel measurement includes aperiodic CSI-RS resources, and if a CSI-RS resource is referred X times by one or more sub-configurations in N sub-configurations indicated for CSI reporting, the CSI-RS resource may be counted X times. Additionally, the number of CSI-RS ports may be counted in accordance with the resources in the N sub-configurations indicated for CSI reporting. However, if the CSI-RS is periodic or semi-persistent, the UE may only measure the CSI-RS resources that occur at least Z′ symbols earlier than a first symbol for transmitting the PUSCH carrying the CSI. The PDCCH carrying the DCI with CSI triggering may not always occur before a valid CSI resource for CSI measurement, which may require the UE to measure the CSI in every CSI-RS resource before receiving the PDCCH. For aperiodic or semi-persistent CSI reporting on the PUSCH and a CSI-RS resource set for channel measurement with periodic or semi-persistent CSI-RS, if a CSI-RS resource is referred Y times by one or more sub-configurations in a CSI report configuration of L sub-configurations, the CSI-RS resource may be counted Y times. Additionally, the number of CSI-RS ports may be counted in accordance with the resources in the L sub-configurations in the CSI report configuration of L sub-configurations. In this case, the UE may need to measure CSIs for all sub-configurations in the CSI report configuration, while network node may only require the feedback of CSIs associated with a subset of the sub-configurations. To make UE and network node more efficient for periodic and semi-persistent CSI-RS reporting, an alternative approach is that the network node can use a MAC-CE to indicate N sub-configurations out of L sub-configurations in the CSI report configuration for CSI measurement. Thus, counting active CSI resources and CSI-RS ports may be the same for all types of CSI-RS, for example, in accordance with N indicated sub-configurations for CSI reporting.

As shown in FIG. 6, at least for the case when periodic or semi-persistent CSI-RS is configured as NZP CSI-RS resource(s) for channel measurements and the CSI report is aperiodic or semi-persistent on the PUSCH, the UE may be provided with a MAC-CE that includes information associated with N sub-configurations out of L sub-configurations in a CSI report configuration for CSI measurement and reporting. The information may be included, for example, in any of the MAC-CEs described in connection with FIG. 5. In some aspects, the UE may not receive a PDCCH that includes DCI with CSI triggering during M symbols after the last symbol that is used to transmit a PUCCH carrying a hybrid automatic repeat request acknowledgement (HARQ-ACK) in response to successful reception of the PDSCH with the MAC-CE. In some aspects, the UE may measure the CSI in accordance with the sub-configurations provided in the MAC-CE. In some aspects, uplink or downlink scheduling DCI may indicate the information associated with the N sub-configurations for CSI reporting.

In some aspects, at least for the case when periodic or semi-persistent CSI-RS is configured as NZP CSI-RS resource(s) for channel measurements and the CSI report is aperiodic or semi-persistent on the PUSCH, the UE may only measure the CSI-RS after the PDCCH. If there is no valid CSI-RS, no CSI may be reported or old CSI may be reported.

In some aspects, for periodic CSI reporting, only periodic CSI-RS may be used for CSI measurements. If there is no L1 or L2 signaling to select N sub-configurations from the L sub-configurations, the UE may measure the CSI associated with the CSI-RS resources in all L sub-configurations. However, if there is L1 or L2 signaling for such selection (e.g., the MAC-CE based signaling described herein), the UE may only measure the CSI associated with the CSI-RS resources in the N indicated sub-configurations.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with CSI-RS reporting.

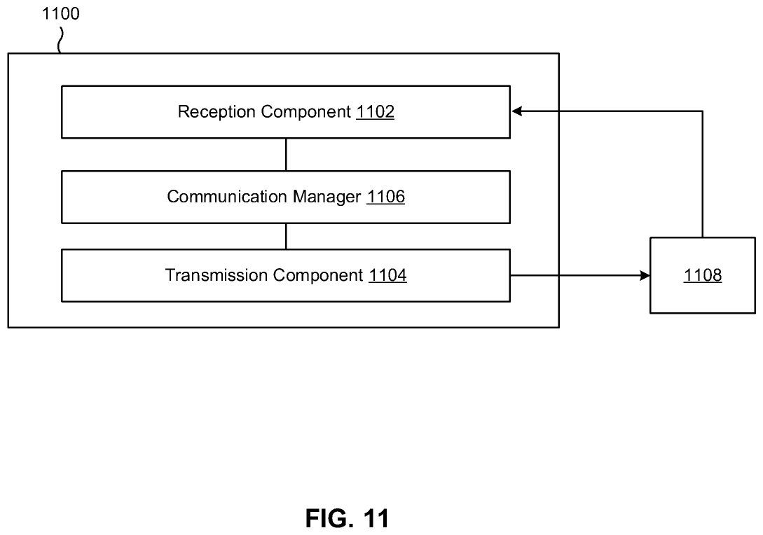

As shown in FIG. 7, in some aspects, process 700 may include receiving an indication of a quantity of sub-configurations, of a set of sub-configurations included within a CSI report configuration, to be used by the UE for reporting CSI via a PUSCH in a single CSI reporting instance (block 710). For example, the UE (e.g., using reception component 1102 and/or communication manager 1106, depicted in FIG. 11) may receive an indication of a quantity of sub-configurations, of a set of sub-configurations included within a CSI report configuration, to be used by the UE for reporting CSI via a PUSCH in a single CSI reporting instance, as described above.

As further shown in FIG. 7, in some aspects, process 700 may include reporting the CSI, via the PUSCH in the single CSI reporting instance, in accordance with the indication of the quantity of sub-configurations (block 720). For example, the UE (e.g., using communication manager 1106, depicted in FIG. 11) may report the CSI, via the PUSCH in the single CSI reporting instance, in accordance with the indication of the quantity of sub-configurations, as described above.

Process 700 may include additional aspects, such as any single aspect or any combination of aspects described below and/or in connection with one or more other processes described elsewhere herein.

In a first aspect, each sub-configuration, of the set of sub-configurations included within the CSI report configuration, is to be used by the UE for reporting CSI in accordance with a measurement of a respective CSI of a quantity of CSIs.

In a second aspect, alone or in combination with the first aspect, the quantity of sub-configurations to be used by the UE for reporting CSI is greater than or equal to one and is less than or equal to the set of sub-configurations included within the CSI report configuration.

In a third aspect, alone or in combination with one or more of the first and second aspects, the quantity of sub-configurations to be used by the UE for reporting CSI is a quantity of sub-configurations to be used by the UE for aperiodically reporting CSI, and wherein reporting the CSI comprises aperiodically reporting the CSI, via the PUSCH in the single CSI reporting instance, in accordance with the indication of the quantity of sub-configurations.

In a fourth aspect, alone or in combination with one or more of the first through third aspects, the indication of the quantity of sub-configurations to be used by the UE for reporting CSI is included in a dedicated field, the dedicated field being included within a CSI aperiodic trigger state indicator.

In a fifth aspect, alone or in combination with one or more of the first through fourth aspects, a single value in the dedicated field is to be applied for a single associated report configuration identifier that is included within an associated report configuration information list.

In a sixth aspect, alone or in combination with one or more of the first through fifth aspects, a single value in the dedicated field is to be applied for a plurality of associated report configuration identifiers that are included within an associated report configuration information list.

In a seventh aspect, alone or in combination with one or more of the first through sixth aspects, the indication of the quantity of sub-configurations to be used by the UE for reporting CSI is included within each associated report configuration identifier of a plurality of associated report configuration identifiers that are indicated in CSI associated report configuration information.

In an eighth aspect, alone or in combination with one or more of the first through seventh aspects, the indication of the quantity of sub-configurations to be used by the UE for reporting CSI is customized for each associated report configuration identifier of the plurality of associated report configuration identifiers.

In a ninth aspect, alone or in combination with one or more of the first through eighth aspects, the quantity of sub-configurations to be used by the UE for reporting CSI is a quantity of sub-configurations to be used by the UE for semi-persistently reporting CSI, and wherein reporting the CSI comprises semi-persistently reporting the CSI, via the PUSCH in the single CSI reporting instance, in accordance with the indication of the quantity of sub-configurations.

In a tenth aspect, alone or in combination with one or more of the first through ninth aspects, the indication of the quantity of sub-configurations to be used by the UE for reporting CSI is included in a dedicated field, the dedicated field being included within a CSI semi-persistent state indicator.

In an eleventh aspect, alone or in combination with one or more of the first through tenth aspects, the UE is configured to use a default quantity of sub-configurations in accordance with failing to receive the indication of the quantity of sub-configurations to be used by the UE for reporting CSI.

In a twelfth aspect, alone or in combination with one or more of the first through eleventh aspects, the default quantity of sub-configurations is equal to the set of sub-configurations included within the CSI report configuration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with CSI-RS reporting.

As shown in FIG. 8, in some aspects, process 800 may include receiving an indication of a quantity of sub-configurations, of a set of sub-configurations included within a CSI report configuration, to be used by the UE for semi-persistently reporting CSI via a PUCCH in a single CSI reporting instance (block 810). For example, the UE (e.g., using reception component 1102 and/or communication manager 1106, depicted in FIG. 11) may receive an indication of a quantity of sub-configurations, of a set of sub-configurations included within a CSI report configuration, to be used by the UE for semi-persistently reporting CSI via a PUCCH in a single CSI reporting instance, as described above.

As further shown in FIG. 8, in some aspects, process 800 may include reporting the CSI, via the PUCCH in the single CSI reporting instance, in accordance with the indication of the quantity of sub-configurations (block 820). For example, the UE (e.g., using communication manager 1106, depicted in FIG. 11) may report the CSI, via the PUCCH in the single CSI reporting instance, in accordance with the indication of the quantity of sub-configurations, as described above.

Process 800 may include additional aspects, such as any single aspect or any combination of aspects described below and/or in connection with one or more other processes described elsewhere herein.

In a first aspect, the indication of the quantity of sub-configurations to be used by the UE for semi-persistently reporting CSI is included within a field, the field being included within a CSI report configuration indicator or within a semi-persistent indicator.

In a second aspect, alone or in combination with the first aspect, each element of a plurality of elements included within the field corresponds to a single sub-configuration of the quantity of sub-configurations to be used by the UE for semi-persistently reporting CSI.

In a third aspect, alone or in combination with one or more of the first and second aspects, each element of a plurality of elements included within the field corresponds to a sub-configuration combination of a quantity of sub-configuration combinations to be used by the UE for semi-persistently reporting CSI.

In a fourth aspect, alone or in combination with one or more of the first through third aspects, process 800 includes receiving an indication of a MAC-CE to be used for semi-persistently reporting on PUCCH activation or deactivation for one or more sub-configurations of the quantity of sub-configurations to be used by the UE for semi-persistently reporting CSI.

In a fifth aspect, alone or in combination with one or more of the first through fourth aspects, process 800 includes receiving a bitmap that includes a plurality of bits that correspond, respectively, to the set of sub-configurations or a set of sub-configuration combinations included within the CSI report configuration, wherein the CSI report configuration is indicated by a first variable.

In a sixth aspect, alone or in combination with one or more of the first through fifth aspects, the first variable is set to a first value to indicate that the CSI report configuration is active, and wherein a bit of the plurality of bits is set to a first value to indicate that a corresponding sub-configuration or sub-configuration combination is active, or is set to a second value to indicate that a corresponding sub-configuration or sub-configuration combination is inactive.

In a seventh aspect, alone or in combination with one or more of the first through sixth aspects, the first variable is set to a second value to indicate that the CSI report configuration, and each sub-configuration or sub-configuration combination included within the CSI report configuration, is inactive.

In an eighth aspect, alone or in combination with one or more of the first through seventh aspects, a bit included within the bitmap is located adjacent to the first variable within an octet or within a plurality of octets of the bitmap, and wherein a set of bits included within the bitmap corresponds to a set of sub-configurations or sub-configuration combinations included within the CSI report configuration.

In a ninth aspect, alone or in combination with one or more of the first through eighth aspects, at least one group of bits is included within an octet of the bitmap or is included within a plurality of octets of the bitmap, where the group of bits includes a plurality of bits and a bit of the plurality of bits is set to a first value to indicate a corresponding sub-configuration or sub-configuration combination.

In a tenth aspect, alone or in combination with one or more of the first through ninth aspects, a single bit is included within the octet of the bitmap, and wherein the single bit is a most significant bit within the bitmap or a least significant bit within the bitmap.

In an eleventh aspect, alone or in combination with one or more of the first through tenth aspects, at least a most significant bit within the octet is reserved in accordance with the quantity of sub-configurations or sub-configuration combinations within the CSI report configuration being less than eight.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with CSI-RS reporting.

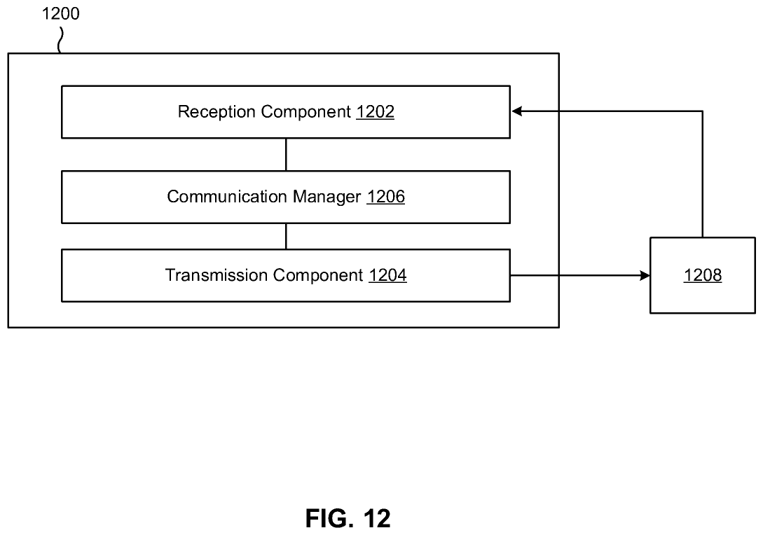

As shown in FIG. 9, in some aspects, process 900 may include transmitting an indication of a quantity of sub-configurations, of a set of sub-configurations included within a CSI report configuration, to be used by a UE for reporting CSI via a PUSCH in a single CSI reporting instance (block 910). For example, the network node (e.g., using transmission component 1204 and/or communication manager 1206, depicted in FIG. 12) may transmit an indication of a quantity of sub-configurations, of a set of sub-configurations included within a CSI report configuration, to be used by a UE for reporting CSI via a PUSCH in a single CSI reporting instance, as described above.

As further shown in FIG. 9, in some aspects, process 900 may include receiving a CSI report, via the PUSCH in the single CSI reporting instance, in accordance with the indication of the quantity of sub-configurations (block 920). For example, the network node (e.g., using reception component 1102 and/or communication manager 1206, depicted in FIG. 12) may receive a CSI report, via the PUSCH in the single CSI reporting instance, in accordance with the indication of the quantity of sub-configurations, as described above.

Process 900 may include additional aspects, such as any single aspect or any combination of aspects described below and/or in connection with one or more other processes described elsewhere herein.

In a first aspect, each sub-configuration, of the set of sub-configurations included within the CSI report configuration, is to be used by the UE for reporting CSI in accordance with a measurement of a respective CSI of a quantity of CSIs.

In a second aspect, alone or in combination with the first aspect, the quantity of sub-configurations to be used by the UE for reporting CSI is greater than or equal to one and is less than or equal to the set of sub-configurations included within the CSI report configuration.

In a third aspect, alone or in combination with one or more of the first and second aspects, the quantity of sub-configurations to be used by the UE for reporting CSI is a quantity of sub-configurations to be used by the UE for aperiodically reporting CSI, and wherein receiving the CSI report comprises aperiodically receiving the CSI report, via the PUSCH in the single CSI reporting instance, in accordance with the indication of the quantity of sub-configurations.

In a fourth aspect, alone or in combination with one or more of the first through third aspects, the indication of the quantity of sub-configurations to be used by the UE for reporting CSI is included in a dedicated field, the dedicated field being included within a CSI aperiodic trigger state indicator.

In a fifth aspect, alone or in combination with one or more of the first through fourth aspects, a single value in the dedicated field is to be applied for a single associated report configuration identifier that is included within an associated report configuration information list.

In a sixth aspect, alone or in combination with one or more of the first through fifth aspects, a single value in the dedicated field is to be applied for a plurality of associated report configuration identifiers that are included within an associated report configuration information list.

In a seventh aspect, alone or in combination with one or more of the first through sixth aspects, the indication of the quantity of sub-configurations to be used by the UE for reporting CSI is included within each associated report configuration identifier of a plurality of associated report configuration identifiers that are indicated in CSI associated report configuration information.

In an eighth aspect, alone or in combination with one or more of the first through seventh aspects, the indication of the quantity of sub-configurations to be used by the UE for reporting CSI is customized for each associated report configuration identifier of the plurality of associated report configuration identifiers.

In a ninth aspect, alone or in combination with one or more of the first through eighth aspects, the quantity of sub-configurations to be used by the UE for reporting CSI is a quantity of sub-configurations to be used by the UE for semi-persistently reporting CSI, and wherein receiving the CSI report comprises semi-persistently receiving the CSI report, via the PUSCH in the single CSI reporting instance, in accordance with the indication of the quantity of sub-configurations.

In a tenth aspect, alone or in combination with one or more of the first through ninth aspects, the indication of the quantity of sub-configurations to be used by the UE for reporting CSI is included in a dedicated field, the dedicated field being included within a CSI semi-persistent state indicator.

In an eleventh aspect, alone or in combination with one or more of the first through tenth aspects, process 900 includes transmitting an indication for the UE to use a default quantity of sub-configurations in accordance with the UE failing to receive the indication of the quantity of sub-configurations to be used by the UE for reporting CSI.

In a twelfth aspect, alone or in combination with one or more of the first through eleventh aspects, the default quantity of sub-configurations is equal to the set of sub-configurations included within the CSI report configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with CSI-RS reporting.

As shown in FIG. 10, in some aspects, process 1000 may include transmitting an indication of a quantity of sub-configurations, of a set of sub-configurations included within a CSI report configuration, to be used by a UE for semi-persistently reporting CSI via a PUCCH in a single CSI reporting instance (block 1010). For example, the network node (e.g., using transmission component 1204 and/or communication manager 1206, depicted in FIG. 12) may transmit an indication of a quantity of sub-configurations, of a set of sub-configurations included within a CSI report configuration, to be used by a UE for semi-persistently reporting CSI via a PUCCH in a single CSI reporting instance, as described above.

As further shown in FIG. 10, in some aspects, process 1000 may include receiving a CSI report, via the PUCCH in the single CSI reporting instance, in accordance with the indication of the quantity of sub-configurations (block 1020). For example, the network node (e.g., using reception component 1202 and/or communication manager 1206, depicted in FIG. 12) may receive a CSI report, via the PUCCH in the single CSI reporting instance, in accordance with the indication of the quantity of sub-configurations, as described above.

Process 1000 may include additional aspects, such as any single aspect or any combination of aspects described below and/or in connection with one or more other processes described elsewhere herein.

In a first aspect, the indication of the quantity of sub-configurations to be used by the UE for semi-persistently reporting CSI is included within a field, the field being included within a CSI report configuration indicator or within a semi-persistent indicator.

In a second aspect, alone or in combination with the first aspect, each element of a plurality of elements included within the field corresponds to a single sub-configuration of the quantity of sub-configurations to be used by the UE for semi-persistently reporting CSI.

In a third aspect, alone or in combination with one or more of the first and second aspects, each element of a plurality of elements included within the field corresponds to a sub-configuration combination of a quantity of sub-configuration combinations to be used by the UE for semi-persistently reporting CSI.

In a fourth aspect, alone or in combination with one or more of the first through third aspects, process 1000 includes transmitting an indication of a MAC-CE to be used for semi-persistently reporting on PUCCH activation or deactivation for one or more sub-configurations of the quantity of sub-configurations to be used by the UE for semi-persistently reporting CSI.

In a fifth aspect, alone or in combination with one or more of the first through fourth aspects, process 1000 includes transmitting a bitmap that includes a plurality of bits that correspond, respectively, to the set of sub-configurations or a set of sub-configuration combinations included within the CSI report configuration, wherein the CSI report configuration is indicated by a first variable.

In a sixth aspect, alone or in combination with one or more of the first through fifth aspects, the first variable is set to a first value to indicate that the CSI report configuration is active, and wherein a bit of the plurality of bits is set to a first value to indicate that a corresponding sub-configuration or sub-configuration combination is active or is set to a second value to indicate that a corresponding sub-configuration or sub-configuration combination is inactive.

In a seventh aspect, alone or in combination with one or more of the first through sixth aspects, the first variable is set to a second value to indicate that the CSI report configuration, and each sub-configuration or sub-configuration combination included within the CSI report configuration, is inactive.

In an eighth aspect, alone or in combination with one or more of the first through seventh aspects, a bit included within the bitmap is located adjacent to the first variable within an octet or within a plurality of octets of the bitmap, and wherein a set of bits included within the bitmap corresponds to a set of sub-configurations or sub-configuration combinations included within the CSI report configuration.

In a ninth aspect, alone or in combination with one or more of the first through eighth aspects, at least one group of bits is included within an octet of the bitmap or is included within a plurality of octets of the bitmap, where the group of bits includes a plurality of bits and a bit of the plurality of bits is set to a first value to indicate a corresponding sub-configuration or sub-configuration combination.

In a tenth aspect, alone or in combination with one or more of the first through ninth aspects, a single bit is included within the octet of the bitmap, and wherein the single bit is a most significant bit within the bitmap or a least significant bit within the bitmap.

In an eleventh aspect, alone or in combination with one or more of the first through tenth aspects, at least a most significant bit within the octet is reserved in accordance with the quantity of sub-configurations or sub-configuration combinations within the CSI report configuration being less than eight.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-6. Additionally, or alternatively, the apparatus 1100 may be configured to perform one or more processes described herein, such as process 700 of FIG. 7, process 800 of FIG. 8, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication of a quantity of sub-configurations, of a set of sub-configurations included within a CSI report configuration, to be used by the UE for reporting CSI via a PUSCH in a single CSI reporting instance. The communication manager 1106 may report the CSI, via the PUSCH in the single CSI reporting instance, in accordance with the indication of the quantity of sub-configurations.

The reception component 1102 may receive an indication of a quantity of sub-configurations, of a set of sub-configurations included within a CSI report configuration, to be used by the UE for semi-persistently reporting CSI via a PUCCH in a single CSI reporting instance. The communication manager 1106 may report the CSI, via the PUCCH in the single CSI reporting instance, in accordance with the indication of the quantity of sub-configurations.

The reception component 1102 may receive an indication of a MAC-CE to be used for semi-persistently reporting on PUCCH activation or deactivation for one or more sub-configurations of the quantity of sub-configurations to be used by the UE for semi-persistently reporting CSI. The reception component 1102 may receive a bitmap that includes a plurality of bits that correspond, respectively, to the set of sub-configurations or a set of sub-configuration combinations included within the CSI report configuration, wherein the CSI report configuration is indicated by a first variable.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5-6. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit an indication of a quantity of sub-configurations, of a set of sub-configurations included within a CSI report configuration, to be used by a UE for reporting CSI via a PUSCH in a single CSI reporting instance. The reception component 1202 may receive a CSI report, via the PUSCH in the single CSI reporting instance, in accordance with the indication of the quantity of sub-configurations.

The transmission component 1204 may transmit an indication for the UE to use a default quantity of sub-configurations in accordance with the UE failing to receive the indication of the quantity of sub-configurations to be used by the UE for reporting CSI.

The transmission component 1204 may transmit an indication of a quantity of sub-configurations, of a set of sub-configurations included within a CSI report configuration, to be used by a UE for semi-persistently reporting CSI via a PUCCH in a single CSI reporting instance. The reception component 1202 may receive a CSI report, via the PUCCH in the single CSI reporting instance, in accordance with the indication of the quantity of sub-configurations.

The transmission component 1204 may transmit an indication of a MAC-CE to be used for semi-persistently reporting on PUCCH activation or deactivation for one or more sub-configurations of the quantity of sub-configurations to be used by the UE for semi-persistently reporting CSI. The transmission component 1204 may transmit a bitmap that includes a plurality of bits that correspond, respectively, to the set of sub-configurations or a set of sub-configuration combinations included within the CSI report configuration, wherein the CSI report configuration is indicated by a first variable.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an indication of a quantity of sub-configurations, of a set of sub-configurations included within a channel state information (CSI) report configuration, to be used by the UE for reporting CSI via a physical uplink shared channel (PUSCH) in a single CSI reporting instance; and reporting the CSI, via the PUSCH in the single CSI reporting instance, in accordance with the indication of the quantity of sub-configurations.

Aspect 2: The method of Aspect 1, wherein each sub-configuration, of the set of sub-configurations included within the CSI report configuration, is to be used by the UE for reporting CSI in accordance with a measurement of a respective CSI of a quantity of CSIs.

Aspect 3: The method of any of Aspects 1-2, wherein the quantity of sub-configurations to be used by the UE for reporting CSI is greater than or equal to one and is less than or equal to the set of sub-configurations included within the CSI report configuration.

Aspect 4: The method of any of Aspects 1-3, wherein the quantity of sub-configurations to be used by the UE for reporting CSI is a quantity of sub-configurations to be used by the UE for aperiodically reporting CSI, and wherein reporting the CSI comprises aperiodically reporting the CSI, via the PUSCH in the single CSI reporting instance, in accordance with the indication of the quantity of sub-configurations.

Aspect 5: The method of Aspect 4, wherein the indication of the quantity of sub-configurations to be used by the UE for reporting CSI is included in a dedicated field, the dedicated field being included within a CSI aperiodic trigger state indicator.

Aspect 6: The method of Aspect 5, wherein a single value in the dedicated field is to be applied for a single associated report configuration identifier that is included within an associated report configuration information list.

Aspect 7: The method of Aspect 5, wherein a single value in the dedicated field is to be applied for a plurality of associated report configuration identifiers that are included within an associated report configuration information list.

Aspect 8: The method of Aspect 4, wherein the indication of the quantity of sub-configurations to be used by the UE for reporting CSI is included within each associated report configuration identifier of a plurality of associated report configuration identifiers that are indicated in CSI associated report configuration information.

Aspect 9: The method of Aspect 8, wherein the indication of the quantity of sub-configurations to be used by the UE for reporting CSI is customized for each associated report configuration identifier of the plurality of associated report configuration identifiers.

Aspect 10: The method of any of Aspects 1-9, wherein the quantity of sub-configurations to be used by the UE for reporting CSI is a quantity of sub-configurations to be used by the UE for semi-persistently reporting CSI, and wherein reporting the CSI comprises semi-persistently reporting the CSI, via the PUSCH in the single CSI reporting instance, in accordance with the indication of the quantity of sub-configurations.

Aspect 11: The method of Aspect 10, wherein the indication of the quantity of sub-configurations to be used by the UE for reporting CSI is included in a dedicated field, the dedicated field being included within a CSI semi-persistent state indicator.

Aspect 12: The method of any of Aspects 1-11, wherein the UE is configured to use a default quantity of sub-configurations in accordance with failing to receive the indication of the quantity of sub-configurations to be used by the UE for reporting CSI.

Aspect 13: The method of Aspect 12, wherein the default quantity of sub-configurations is equal to the set of sub-configurations included within the CSI report configuration.

Aspect 14: A method of wireless communication performed by a user equipment (UE), comprising: receiving an indication of a quantity of sub-configurations, of a set of sub-configurations included within a channel state information (CSI) report configuration, to be used by the UE for semi-persistently reporting CSI via a physical uplink control channel (PUCCH) in a single CSI reporting instance; and reporting the CSI, via the PUCCH in the single CSI reporting instance, in accordance with the indication of the quantity of sub-configurations.

Aspect 15: The method of Aspect 14, wherein the indication of the quantity of sub-configurations to be used by the UE for semi-persistently reporting CSI is included within a field, the field being included within a CSI report configuration indicator or within a semi-persistent indicator.

Aspect 16: The method of Aspect 15, wherein each element of a plurality of elements included within the field corresponds to a single sub-configuration of the quantity of sub-configurations to be used by the UE for semi-persistently reporting CSI.

Aspect 17: The method of Aspect 15, wherein each element of a plurality of elements included within the field corresponds to a sub-configuration combination of a quantity of sub-configuration combinations to be used by the UE for semi-persistently reporting CSI.

Aspect 18: The method of Aspect 15, further comprising receiving an indication of a medium access control (MAC) control element to be used for semi-persistently reporting on PUCCH activation or deactivation for one or more sub-configurations of the quantity of sub-configurations to be used by the UE for semi-persistently reporting CSI.

Aspect 19: The method of Aspect 18, further comprising receiving a bitmap that includes a plurality of bits that correspond, respectively, to the set of sub-configurations or a set of sub-configuration combinations included within the CSI report configuration, wherein the CSI report configuration is indicated by a first variable.

Aspect 20: The method of Aspect 19, wherein the first variable is set to a first value to indicate that the CSI report configuration is active, and wherein a bit of the plurality of bits is set to a first value to indicate that a corresponding sub-configuration or sub-configuration combination is active, or is set to a second value to indicate that a corresponding sub-configuration or sub-configuration combination is inactive.

Aspect 21: The method of Aspect 19, wherein the first variable is set to a second value to indicate that the CSI report configuration, and each sub-configuration or sub-configuration combination included within the CSI report configuration, is inactive.

Aspect 22: The method of Aspect 19, wherein a bit included within the bitmap is located adjacent to the first variable within an octet or within a plurality of octets of the bitmap, and wherein a set of bits included within the bitmap corresponds to a set of sub-configurations or sub-configuration combinations included within the CSI report configuration.

Aspect 23: The method of Aspect 22, wherein at least one group of bits is included within an octet of the bitmap or is included within a plurality of octets of the bitmap, wherein the group of bits includes a plurality of bits and a bit of the plurality of bits is set to a first value to indicate a corresponding sub-configuration or sub-configuration combination.

Aspect 24: The method of Aspect 23, wherein a single bit is included within the octet of the bitmap, and wherein the single bit is a most significant bit within the bitmap or a least significant bit within the bitmap.

Aspect 25: The method of Aspect 22, wherein at least a most significant bit within the octet is reserved in accordance with the quantity of sub-configurations or sub-configuration combinations within the CSI report configuration being less than eight.

Aspect 26: A method of wireless communication performed by a network node, comprising: transmitting an indication of a quantity of sub-configurations, of a set of sub-configurations included within a channel state information (CSI) report configuration, to be used by a user equipment (UE) for reporting CSI via a physical uplink shared channel (PUSCH) in a single CSI reporting instance; and receiving a CSI report, via the PUSCH in the single CSI reporting instance, in accordance with the indication of the quantity of sub-configurations.

Aspect 27: The method of Aspect 26, wherein each sub-configuration, of the set of sub-configurations included within the CSI report configuration, is to be used by the UE for reporting CSI in accordance with a measurement of a respective CSI of a quantity of CSIs.

Aspect 28: The method of any of Aspects 26-27, wherein the quantity of sub-configurations to be used by the UE for reporting CSI is greater than or equal to one and is less than or equal to the set of sub-configurations included within the CSI report configuration.

Aspect 29: The method of any of Aspects 26-28, wherein the quantity of sub-configurations to be used by the UE for reporting CSI is a quantity of sub-configurations to be used by the UE for aperiodically reporting CSI, and wherein receiving the CSI report comprises aperiodically receiving the CSI report, via the PUSCH in the single CSI reporting instance, in accordance with the indication of the quantity of sub-configurations.

Aspect 30: The method of Aspect 29, wherein the indication of the quantity of sub-configurations to be used by the UE for reporting CSI is included in a dedicated field, the dedicated field being included within a CSI aperiodic trigger state indicator.

Aspect 31: The method of Aspect 30, wherein a single value in the dedicated field is to be applied for a single associated report configuration identifier that is included within an associated report configuration information list.

Aspect 32: The method of Aspect 30, wherein a single value in the dedicated field is to be applied for a plurality of associated report configuration identifiers that are included within an associated report configuration information list.

Aspect 33: The method of Aspect 29, wherein the indication of the quantity of sub-configurations to be used by the UE for reporting CSI is included within each associated report configuration identifier of a plurality of associated report configuration identifiers that are indicated in CSI associated report configuration information.

Aspect 34: The method of Aspect 33, wherein the indication of the quantity of sub-configurations to be used by the UE for reporting CSI is customized for each associated report configuration identifier of the plurality of associated report configuration identifiers.

Aspect 35: The method of any of Aspects 26-34, wherein the quantity of sub-configurations to be used by the UE for reporting CSI is a quantity of sub-configurations to be used by the UE for semi-persistently reporting CSI, and wherein receiving the CSI report comprises semi-persistently receiving the CSI report, via the PUSCH in the single CSI reporting instance, in accordance with the indication of the quantity of sub-configurations.

Aspect 36: The method of Aspect 35, wherein the indication of the quantity of sub-configurations to be used by the UE for reporting CSI is included in a dedicated field, the dedicated field being included within a CSI semi-persistent state indicator.

Aspect 37: The method of any of Aspects 26-36, further comprising transmitting an indication for the UE to use a default quantity of sub-configurations in accordance with the UE failing to receive the indication of the quantity of sub-configurations to be used by the UE for reporting CSI.

Aspect 38: The method of Aspect 37, wherein the default quantity of sub-configurations is equal to the set of sub-configurations included within the CSI report configuration.

Aspect 39: A method of wireless communication performed by a network node, comprising: transmitting an indication of a quantity of sub-configurations, of a set of sub-configurations included within a channel state information (CSI) report configuration, to be used by a user equipment (UE) for semi-persistently reporting CSI via a physical uplink control channel (PUCCH) in a single CSI reporting instance; and receiving a CSI report, via the PUCCH in the single CSI reporting instance, in accordance with the indication of the quantity of sub-configurations.

Aspect 40: The method of Aspect 39, wherein the indication of the quantity of sub-configurations to be used by the UE for semi-persistently reporting CSI is included within a field, the field being included within a CSI report configuration indicator or within a semi-persistent indicator.

Aspect 41: The method of Aspect 40, wherein each element of a plurality of elements included within the field corresponds to a single sub-configuration of the quantity of sub-configurations to be used by the UE for semi-persistently reporting CSI.

Aspect 42: The method of Aspect 40, wherein each element of a plurality of elements included within the field corresponds to a sub-configuration combination of a quantity of sub-configuration combinations to be used by the UE for semi-persistently reporting CSI.

Aspect 43: The method of Aspect 40, further comprising transmitting an indication of a medium access control (MAC) control element to be used for semi-persistently reporting on PUCCH activation or deactivation for one or more sub-configurations of the quantity of sub-configurations to be used by the UE for semi-persistently reporting CSI.

Aspect 44: The method of Aspect 43, further comprising transmitting a bitmap that includes a plurality of bits that correspond, respectively, to the set of sub-configurations or a set of sub-configuration combinations included within the CSI report configuration, wherein the CSI report configuration is indicated by a first variable.

Aspect 45: The method of Aspect 44, wherein the first variable is set to a first value to indicate that the CSI report configuration is active, and wherein a bit of the plurality of bits is set to a first value to indicate that a corresponding sub-configuration or sub-configuration combination is active or is set to a second value to indicate that a corresponding sub-configuration or sub-configuration combination is inactive.

Aspect 46: The method of Aspect 44, wherein the first variable is set to a second value to indicate that the CSI report configuration, and each sub-configuration or sub-configuration combination included within the CSI report configuration, is inactive.

Aspect 47: The method of Aspect 44, wherein a bit included within the bitmap is located adjacent to the first variable within an octet or within a plurality of octets of the bitmap, and wherein a set of bits included within the bitmap corresponds to a set of sub-configurations or sub-configuration combinations included within the CSI report configuration.

Aspect 48: The method of Aspect 47, wherein at least one group of bits is included within an octet of the bitmap or is included within a plurality of octets of the bitmap, wherein the group of bits includes a plurality of bits and a bit of the plurality of bits is set to a first value to indicate a corresponding sub-configuration or sub-configuration combination.

Aspect 49: The method of Aspect 48, wherein a single bit is included within the octet of the bitmap, and wherein the single bit is a most significant bit within the bitmap or a least significant bit within the bitmap.

Aspect 50: The method of Aspect 47, wherein at least a most significant bit within the octet is reserved in accordance with the quantity of sub-configurations or sub-configuration combinations within the CSI report configuration being less than eight.

Aspect 51: An apparatus for wireless communication at a device, comprising a processor; memory coupled with the processor; and instructions stored in the memory and executable by the processor to cause the apparatus to perform the method of one or more of Aspects 1-50.

Aspect 52: A device for wireless communication, comprising one or more memories and a set of one or more processors, the set of one or more processors configured to perform the method of one or more of Aspects 1-50.

Aspect 53: An apparatus for wireless communication, comprising at least one means for performing the method of one or more of Aspects 1-50.

Aspect 54: A non-transitory computer-readable medium storing code for wireless communication, the code comprising instructions executable by a processor to perform the method of one or more of Aspects 1-50.

Aspect 55: A non-transitory computer-readable medium storing a set of instructions for wireless communication, the set of instructions comprising one or more instructions that, when executed by a set of one or more processors, cause the device to perform the method of one or more of Aspects 1-50.

The foregoing disclosure provides illustration and description but is not intended to be exhaustive or to limit the aspects to the precise forms disclosed. Modifications and variations may be made in light of the above disclosure or may be acquired from practice of the aspects.

In some aspects, a single processor may perform all of the operations described as being performed by the one or more processors and/or the set of one or more processors. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
a set of one or more processors, the set of one or more processors configured to:
receive an indication of a quantity of sub-configurations, of a set of sub-configurations included within a channel state information (CSI) report configuration, to be used by the UE for reporting CSI via a physical uplink shared channel (PUSCH) in a single CSI reporting instance; and
report the CSI, via the PUSCH in the single CSI reporting instance, in accordance with the indication of the quantity of sub-configurations.

2. The UE of claim 1, wherein each sub-configuration, of the set of sub-configurations included within the CSI report configuration, is to be used by the UE for reporting CSI in accordance with a measurement of a respective CSI of a quantity of CSIs.

3. The UE of claim 1, wherein the quantity of sub-configurations to be used by the UE for reporting CSI is greater than or equal to one and is less than or equal to the set of sub-configurations included within the CSI report configuration.

4. The UE of claim 1, wherein the quantity of sub-configurations to be used by the UE for reporting CSI is a quantity of sub-configurations to be used by the UE for aperiodically reporting CSI, and wherein reporting the CSI comprises aperiodically reporting the CSI, via the PUSCH in the single CSI reporting instance, in accordance with the indication of the quantity of sub-configurations.

5. The UE of claim 4, wherein the indication of the quantity of sub-configurations to be used by the UE for reporting CSI is included in a dedicated field, the dedicated field being included within a CSI aperiodic trigger state indicator.

6. The UE of claim 5, wherein a single value in the dedicated field is to be applied for a single associated report configuration identifier that is included within an associated report configuration information list.

7. The UE of claim 5, wherein a single value in the dedicated field is to be applied for a plurality of associated report configuration identifiers that are included within an associated report configuration information list.

8. The UE of claim 4, wherein the indication of the quantity of sub-configurations to be used by the UE for reporting CSI is included within each associated report configuration identifier of a plurality of associated report configuration identifiers that are indicated in CSI associated report configuration information.

9. The UE of claim 8, wherein the indication of the quantity of sub-configurations to be used by the UE for reporting CSI is customized for each associated report configuration identifier of the plurality of associated report configuration identifiers.

10. The UE of claim 1, wherein the quantity of sub-configurations to be used by the UE for reporting CSI is a quantity of sub-configurations to be used by the UE for semi-persistently reporting CSI, and wherein reporting the CSI comprises semi-persistently reporting the CSI, via the PUSCH in the single CSI reporting instance, in accordance with the indication of the quantity of sub-configurations.

11. The UE of claim 10, wherein the indication of the quantity of sub-configurations to be used by the UE for reporting CSI is included in a dedicated field, the dedicated field being included within a CSI semi-persistent state indicator.

12. The UE of claim 1, wherein the UE is configured to use a default quantity of sub-configurations in accordance with failing to receive the indication of the quantity of sub-configurations to be used by the UE for reporting CSI.

13. The UE of claim 12, wherein the default quantity of sub-configurations is equal to the set of sub-configurations included within the CSI report configuration.

14. A user equipment (UE) for wireless communication, comprising:
one or more memories; and
a set of one or more processors, the set of one or more processors configured to:
receive an indication of a quantity of sub-configurations, of a set of sub-configurations included within a channel state information (CSI) report configuration, to be used by the UE for semi-persistently reporting CSI via a physical uplink control channel (PUCCH) in a single CSI reporting instance; and
report the CSI, via the PUCCH in the single CSI reporting instance, in accordance with the indication of the quantity of sub-configurations.

15. The UE of claim 14, wherein the indication of the quantity of sub-configurations to be used by the UE for semi-persistently reporting CSI is included within a field, the field being included within a CSI report configuration indicator or within a semi-persistent indicator.

16. The UE of claim 15, wherein each element of a plurality of elements included within the field corresponds to a single sub-configuration of the quantity of sub-configurations to be used by the UE for semi-persistently reporting CSI.

17. The UE of claim 15, wherein each element of a plurality of elements included within the field corresponds to a sub-configuration combination of a quantity of sub-configuration combinations to be used by the UE for semi-persistently reporting CSI.

18. The UE of claim 15, wherein the set of one or more processors are further configured to receive an indication of a medium access control (MAC) control element to be used for semi-persistently reporting on PUCCH activation or deactivation for one or more sub-configurations of the quantity of sub-configurations to be used by the UE for semi-persistently reporting CSI.

19. The UE of claim 18, wherein the set of one or more processors are further configured to receive a bitmap that includes a plurality of bits that correspond, respectively, to the set of sub-configurations or a set of sub-configuration combinations included within the CSI report configuration, wherein the CSI report configuration is indicated by a first variable.

20-25. (canceled)

26. A network node for wireless communication, comprising:
one or more memories; and
a set of one or more processors, the set of one or more processors configured to:
transmit an indication of a quantity of sub-configurations, of a set of sub-configurations included within a channel state information (CSI) report configuration, to be used by a user equipment (UE) for reporting CSI via a physical uplink shared channel (PUSCH) in a single CSI reporting instance; and
receive a CSI report, via the PUSCH in the single CSI reporting instance, in accordance with the indication of the quantity of sub-configurations.

27-30. (canceled)
